(19) United States
(12) Patent Application Publication
(10) Pub. No.: US 2013/0343320 A1
(43) Pub. Date: Dec. 26, 2013

(54) TERMINAL DEVICE, BASE STATION DEVICE, AND WIRELESS COMMUNICATION SYSTEM

(71) Applicants: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(72) Inventors: Osamu Nakamura, Osaka-shi (JP); Hiroki Takahashi, Osaka-shi (JP); Jungo Goto, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/003,181

(22) PCT Filed: Mar. 5, 2012
(86) PCT No.: PCT/JP2012/055540

§ 371 Date: Sep. 4, 2013

(30) Foreign Application Priority Data
Mar. 7, 2011 (JP) 2011-049655

(51) Int. Cl. H04W 72/04

(52) U.S. Cl. CPC H04W 72/0466
USPC 370/329

(57) ABSTRACT

A DMRS generator generates reference signals used for demodulation to which orthogonal codes, which are a code for one layer and a code for another layer being orthogonal to each other, are assigned. Concerning each of layers up to the predetermined number of layers, codes are assigned to the reference signals according to the same rules as assignment rules employed in a different terminal device. Accordingly, the throughput can be increased.

### TECHNICAL FIELD

The present invention relates to a terminal device, a base station device, and a wireless communication system.

This application claims priority based on Japanese Patent Application No. 2011-049655 filed in the Japan Patent Office on Mar. 7, 2011, the entire contents of which are incorporated by reference herein.

### BACKGROUND ART

With the use of LTE (Long Term Evolution) Release 8 (Rel-8), which is a wireless communication system standardized by 3GPP (3rd Generation Partnership Project), communication can be performed by utilizing a frequency band at a maximum of 20 MHz. As a transmission method for the downlink (communication from a base station device to a terminal device) in LTE Rel-8, OFDM (Orthogonal Frequency Division Multiplexing) is used due to a high tolerance to frequency selective fading, a high affinity with MIMO (Multiple Input Multiple Output) transmission, etc. In contrast, for the uplink in LTE Rel-8 (communication from a terminal device to a base station device), the cost and the scale of a terminal device (also called a mobile terminal device, a mobile station device, or a terminal) are important factors. OFDM has a high PAPR (Peak to Average Power Ratio), and thus, a power amplifier having a large linear region is required. Accordingly, OFDM is not suitable for the uplink transmission. Thus, SC-FDMA (Single Carrier Frequency Division Multiple Access) having a low PAPR is used.

In 3GPP, the standards of LTE Rel-10 and beyond are called LTE-A (LTE-Advanced) and standardization of LTE-A is now being promoted. MIMO transmission has not been specified in the uplink in LTE Rel-8, however, it is specified in Rel-10, and SU-MIMO (Single User MIMO) transmission utilizing a maximum of four transmission antennas can be implemented. If four transmission antennas are used, different items of data are transmitted from the individual transmission antennas, and thus, transmission using four layers (also called ranks or streams) can be performed.

A base station device estimates a channel between each layer of each terminal device and each reception antenna by using a received reference signal, generates a ZF (Zero Forcing) weight or a MMSE (Minimum Mean Square Error) weight by using an obtained channel estimation value, and multiplies a received signal by the obtained weight, thereby making it possible to divide a multiplexed signal.

In this case, in order to perform channel estimation for each layer, it is necessary that DMRS (DeModulation Reference Signal) transmitted in each layer be configured such that it can be separated in a base station device. As a technique for separating DMRS, CS (Cyclic Shift) is utilized in Rel-10. The cyclic shift is a technique for transmitting the same DMRS sequence by providing different cyclic delays to individual layers of the DMRS sequence in a time domain. Accordingly, the transmission DMRS sequence of the individual layers is cyclically shifted in a DFT (Discrete Fourier Transform) duration. As a result, it is possible for the base station device to separate an impulse response of each layer in a delay time domain. In this case, if the number of layers is two, providing of a cyclic delay amount, which is half the number of DFT points, to DMRS to be transmitted in the second layer is equal to multiplying of each subcarrier by {+1, −1, +1, −1, . . . } in the frequency domain. Accordingly, the base station device performs despread processing on two adjacent subcarriers, thereby making it possible to obtain channel characteristics of each layer.

The frame of PUSCH (Physical Uplink Shared Channel), which is an LTE data channel, is configured, such as that shown in FIG. 27. One frame f is constituted by ten subframes. One subframe sf is constituted by 14 SC-FDMA symbols ss. In each of the fourth and eleventh SC-FDMA symbols of the subframe, DMRS is transmitted. Then, a terminal device multiplies the two DMRSs in each subframe by [+1, +1] or [+1, −1] and transmits the resulting DMRSs, and the base station device performs despread processing on the two received DMRSs, thereby making it possible to estimate a channel between each of the transmission antennas and each of the reception antennas. Code used for these two DMRSs is referred to as “OCC (Orthogonal Cover Code)”.

LTE Rel-10 has already introduced that the above-described OCC is added to CS in order to enhance the orthogonality. The value of CS and the pattern of OCC to be employed in each layer are determined by a three-bit CSI (CS Index) supplied from the base station device (see Table 5.5.2.1.1-1 in Non Patent Literature 1). The value of CS and OCC employed in each layer are associated with each other, as shown in FIG. 28, and the value of CS and OCC can be determined without the need to supply information concerning the value of CS and OCC for each layer. For example, FIG. 28 shows that if, among eight CSI values, ‘010’ is received as the CSI value from the base station device, DMRS of layer 1 provides 3 as CS, DMRS of layer 2 provides 9 as CS, DMRS of layer 3 provides 6 as CS, and DMRS of layer 4 provides 0 as CS. FIG. 28 also shows that, concerning OCC, DMRS is spread by [+1, −1] in layer 1 and layer 2, and DMRS is spread by [+1, +1] in layer 3 and layer 4. If the number of layers is less than four, for example, if the number of layers is three, CS and OCC only concerning layer 1 through layer 3 are used.

In FIG. 2, if CSI=‘011’ is assigned to a certain terminal device and CSI=‘101’ is assigned to another terminal device, OCC patterns used in the individual CSI are different. Thus, MU-MIMO (Multi-User MIMO) performed by two terminal devices can be implemented.

### CITATION LIST

### Non Patent Literature

NPL 1: 3GPP TS 36.211 V10.0.0

### SUMMARY OF INVENTION

### Technical Problem

In the related art, however, the maximum number of layers is defined as four, and thus, it is difficult to further increase the throughput in a communication system.

The present invention has been made in view of the above-described background, and it is an object of the present invention to provide a terminal device, a base station device, and a wireless communication system in which the throughput can be increased.

### Solution to Problem

(1) This invention has been made to solve the above-described problem, and according to one aspect of the present invention, there is provided a terminal device in a wireless communication system which includes a different terminal device that transmits a predetermined number of layers as a maximum number of layers to a base station device, the terminal device having a maximum number of layers which is greater than the predetermined number of layers. The terminal device includes a reference signal generator that generates reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the different terminal device.

(2) According to another aspect of the present invention, in the above-described terminal device, the orthogonal codes may be codes constituted by cyclic shifts and orthogonal cover codes.

(3) According to another aspect of the present invention, in the above-described terminal device, the reference signals generated by the reference signal generator may be codes which increase, in a case in which the terminal device performs MU-MIMO with the different terminal device, a maximum total number of transmission layers of the terminal device and the number of transmission layers of the different terminal device to at least twice as many as the predetermined number of layers.

(4) According to another aspect of the present invention, in the above-described terminal device, the reference signals generated by the reference signal generator may be codes to which, concerning each of layers exceeding the predetermined number of layers, one of combinations of the codes assigned up to the predetermined number of layers according to the assignment rules is assigned in an order opposite to an order of the assignment rules.

(5) According to another aspect of the present invention, in the above-described terminal device, the orthogonal cover codes may be arranged after being spread in a time domain, and the reference signals may be codes in which the orthogonal cover codes assigned to the different terminal device are orthogonal to the orthogonal cover codes assigned to the terminal device.

(6) According to another aspect of the present invention, in the above-described terminal device, a spreading factor of the orthogonal cover codes may be four.

(7) According to another aspect of the present invention, there is provided a base station device which receives a predetermined number of layers as a maximum number of layers from a first terminal device. The base station includes: a scheduling unit that generates control information for causing the second terminal device to generate reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device; and a transmitter that transmits the control information to the second terminal device.

(8) According to another aspect of the present invention, there is provided a wireless communication system including: a base station device; a first terminal device which transmits a predetermined number of layers as a maximum number of layers to the base station device; and a second terminal device. The base station device includes a scheduling unit that generates control information for causing the second terminal device to generate reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device, and a transmitter that transmits the control information to the second terminal device. The second terminal device includes a reference signal generator that generates, on the basis of the control information, reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device.

### Advantageous Effects of Invention

According to the present invention, the throughput can be increased.

### BRIEF DESCRIPTION OF DRAWINGS

FIG. 1 is a schematic block diagram illustrating the configuration of a wireless communication system in a first embodiment of the present invention.

FIG. 2 is a schematic block diagram illustrating the configuration of a terminal device according to this embodiment.

FIG. 3 is a schematic block diagram illustrating the configuration of a DMRS generator according to this embodiment.

FIG. 4 illustrates a table showing an example of codes stored in a code storage section according to this embodiment.

FIG. 5 is a schematic block diagram illustrating the configuration of a base station device according to this embodiment.

FIG. 6 is a schematic block diagram illustrating the configuration of a channel estimating unit according to this embodiment.

FIG. 7 is a schematic block diagram illustrating the configuration of a reception-antenna channel estimating unit according to this embodiment.

FIG. 8 is a schematic diagram illustrating time responses according to this embodiment.

FIG. 9 illustrates a table showing an example of codes according to a second embodiment of the present invention.

FIG. 10 is a schematic diagram illustrating an example in which a table is generated according to this embodiment.

FIG. 11 is another schematic diagram illustrating an example in which a table is generated according to this embodiment.

FIG. 12 is another schematic diagram illustrating an example in which a table is generated according to this embodiment.

FIG. 13 illustrates a table showing another example of codes according to this embodiment.

FIG. 14 is a schematic block diagram illustrating the configuration of a base station device according to this embodiment.

FIG. 15 illustrates a table showing an example of DMRS indexes.

FIG. 16 is a schematic diagram illustrating a frame configuration according to a third embodiment of the present invention.

FIG. 17 illustrates a table showing an example of codes according to this embodiment.

FIG. 18 is a schematic diagram illustrating an example in which a table is generated according to this embodiment.

FIG. 19 is another schematic diagram illustrating an example in which a table is generated according to this embodiment.

FIG. 20 is another schematic diagram illustrating an example in which a table is generated according to this embodiment.

FIG. 21 illustrates a table showing another example of codes according to this embodiment.

FIG. 22 is a schematic block diagram illustrating the configuration of a terminal device according to this embodiment.

FIG. 23 is a schematic block diagram illustrating the configuration of a DMRS generator according to this embodiment.

FIG. 24 is a schematic block diagram illustrating the configuration of a base station device according to this embodiment.

FIG. 25 is a schematic block diagram illustrating the configuration of a channel estimating unit according to this embodiment.

FIG. 26 is a schematic block diagram illustrating the configuration of a reception-antenna channel estimating unit according to this embodiment.

FIG. 27 is a schematic diagram illustrating a frame configuration according to the related art.

FIG. 28 illustrates a table showing codes according to the related art.

### DESCRIPTION OF EMBODIMENTS

In this specification, a reference signal is a signal which is known both for a transmission side and a reception side and is used for estimating the channel state. This signal is equivalent to a so-called “pilot signal (pilot symbol)” in W-CDMA (Wideband Code Division Multiple Access; 3G). In the following embodiments, the number of transmission antennas is eight, however, it is not restricted thereto.

Embodiments of the present invention will now be described below with reference to the drawings.

### First Embodiment

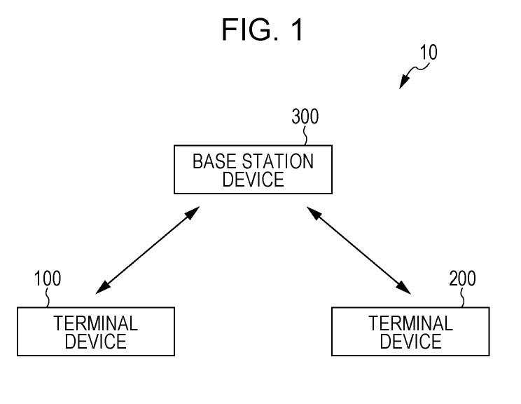

A first embodiment of the present invention will be described below. FIG. 1 is a schematic block diagram illustrating the configuration of a wireless communication system 10 in the first embodiment of the present invention. The wireless communication system 10 includes terminal devices 100 and 200 and a base station device 300. In FIG. 1, each of the terminal devices 100 and 200 is singly shown. However, a plurality of terminal devices 100 and a plurality of terminal devices 200 may be disposed.

The terminal device 100 is a terminal device which performs wireless communication with the base station device 300. The maximum number of layers of the terminal device 100 which may be used for transmission is eight. The terminal device 200 is a terminal device based on the above-described LTE-A. The maximum number of layers of the terminal device 200 which may be used for transmission is four. The base station device 300 is a base station device which performs wireless communication with the terminal devices 100 and 200. The configuration of the terminal device 200 is similar to that of the terminal device 100, except that the maximum number of layers is four. Thus, a detailed explanation of the terminal device 200 will be omitted.

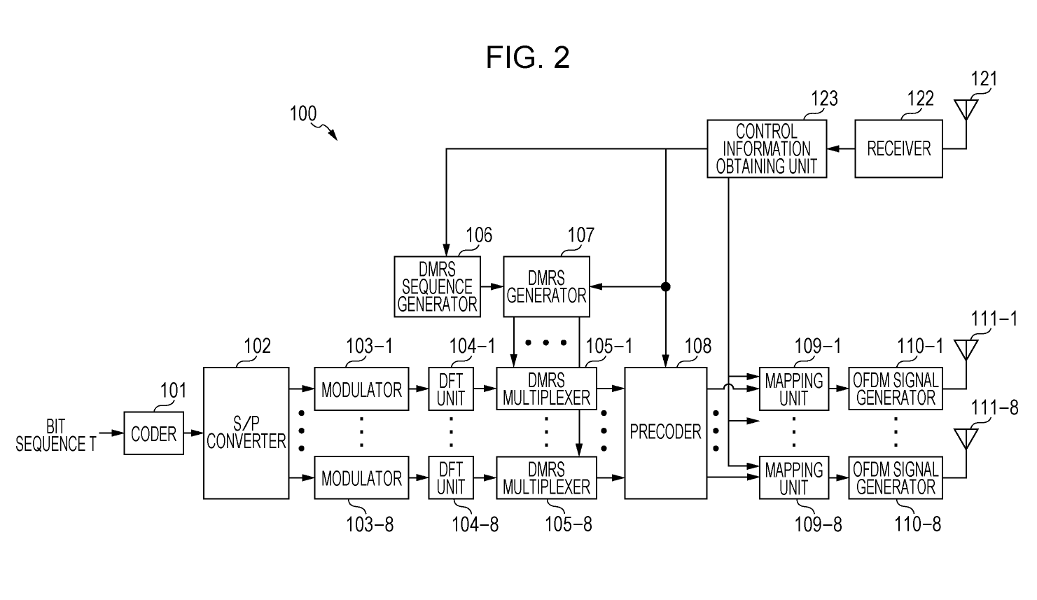

FIG. 2 is a schematic block diagram illustrating the configuration of the terminal device 100 according to this embodiment. The terminal device 100 includes a coder 101, a S/P (Serial/Parallel) converter 102, modulators 103-1 through 103-8, DFT (Discrete Fourier Transform) units 104-1 through 104-8, DMRS (DeModulation Reference Signal; a reference signal for demodulation) multiplexers 105-1 through 105-8, a DMRS sequence generator 106, a DMRS generator 107, a precoder 108, mapping units 109-1 through 109-8, OFDM (Orthogonal Frequency Division Multiplex) signal generators 110-1 through 110-8, transmission antennas 111-1 through 111-8, a reception antenna 121, a receiver 122, and a control information obtaining unit 123.

A bit sequence T, which is information to be transmitted to the base station device 300, is subjected to error-correcting coding in the coder 101. An output from the coder 101 is subjected to serial-to-parallel conversion by the S/P converter 102 so that parallel outputs having the same number as layers can be obtained, and then, the parallel outputs are input into the modulators 103-1 through 103-8. It is assumed that the number of layers (number of ranks or streams) is indicated by L. In this case, 1≦L≦8 is established. If the number L of layers is less than 8, the S/P converter 102 does not output the parallel bit sequence T to the modulators 103-L+1 through 103-8, and thus, the modulators 103-L+1 through 103-8 are not operated. In FIG. 2, only one coder 101 is provided. However, the configuration of the terminal device 100 may be as follows: the bit sequence T may be input into a plurality of (two through L) coders 101 after being subjected to S/P conversion and may be input into the modulators 103-1 through 103-8 of the individual layers by using layer mapping units. The modulators 103-1 through 103-8 each convert the bit sequence input from the S/P converter 102 into symbols, such as QPSK (Quadrature Phase Shift Keying) or 16QAM (Quadrature Amplitude Modulation) symbols.

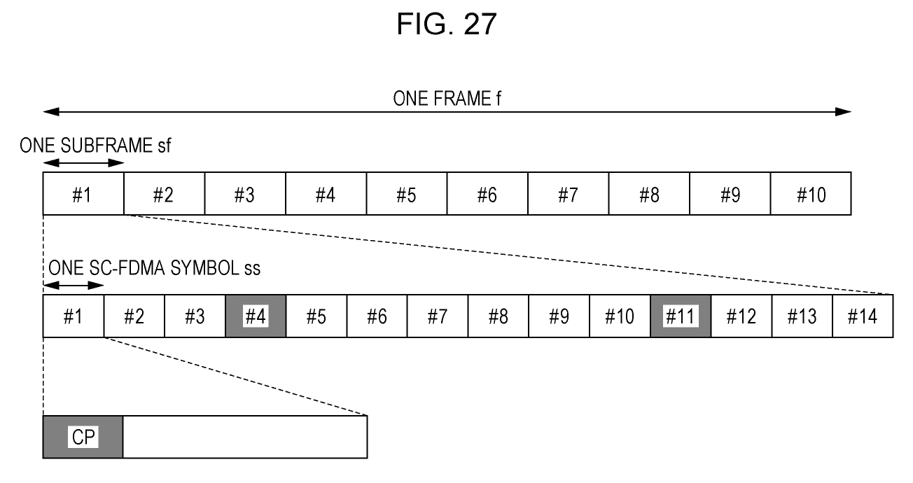

Outputs from the modulators 103-1 through 103-8 are subjected to Discrete Fourier Transform (DFT) by the DFT units 104-1 through 104-8 in every group of N_{DFT} symbols, so that N_{DFT} time domain signals are transformed into N_{DFT} frequency domain signals. The DFT units 104-1 through 104-8 output frequency domain signals (data SC-FDMA symbols) to the DMRS multiplexers 105-1 through 105-8, respectively. The DMRS multiplexers 105-1 through 105-8 each multiplex the N_{DFT} frequency domain signals with a demodulation reference signal (DMRS) input from the DMRS generator 107 in a time division multiplexing manner, thereby forming the frame shown in FIG. 27. The frame shown in FIG. 27 will be discussed later.

Outputs from the DMRS multiplexers 105-1 through 105-8 are input into the precoder 108. The precoder 108 selects an eight-row L-column precoding matrix on the basis of PMI (Precoding Matrix Indicator) information which is supplied from the base station device 300 and which is obtained by the control information obtaining unit 123. The precoder 108 multiplies the outputs from the DMRS multiplexers 105-1 through 105-8 by the selected precoding matrix. Outputs from the precoder 108 are input into the mapping units 109-1 through 109-8. The mapping units 109-1 through 109-8 map the outputs from the precoder 108 to frequencies specified by assignment information which is supplied from the base station device 300 and which is obtained by the control information obtaining unit 123.

Outputs from the mapping units 109-1 through 109-8 are input into the OFDM signal generators 110-1 through 110-8, respectively. The OFDM signal generators 110-1 through 110-8 perform Inverse Fast Fourier Transform (IFFT) on the outputs from the mapping units 109-1 through 109-8, thereby transforming the frequency domain signals into time domain signals. The OFDM signal generators 110-1 through 110-8 each insert CP (Cyclic Prefix) into the time domain signal in units of SC-FDMA symbols. The OFDM signal generators 110-1 through 110-8 also perform processing, such as D/A (digital-to-analog) conversion, analog filtering, up-conversion to a carrier frequency, on each of the SC-FDMA symbols into which a CP is inserted, and then transmit the resulting signals from the transmission antennas 111-1 through 111-8, respectively.

The receiver 122 receives a signal transmitted from the base station device 300 via the reception antenna 121. The control information obtaining unit 123 obtains control information which has been determined by the base station device 300 from the signal received by the receiver 122. This control information includes CSI (Cyclic Shift Index) information and the above-described PMI information and assignment information. The CSI information is information for specifying a code used for DMRS of each layer. The PMI information is information for specifying a precoding matrix by which a transmission signal to be transmitted is multiplied. In this case, by specifying the precoding matrix, the number of layers is also specified. The assignment information is information for specifying a frequency band used for transmission by the terminal device 100.

FIG. 27 is a conceptual diagram illustrating the frame configuration used in this embodiment. The configuration of the frame used in this embodiment is similar to that of PUSCH of LTE. A frame f is, as shown in FIG. 27, constituted by 10 subframes sf arranged in the time direction. One subframe sf has a total of 14 symbols constituted by 12 data SC-FDMA symbols ss and two demodulation reference signal (DMRS) symbols. Among the 14 symbols forming one subframe, DMRS is inserted into each of the fourth and eleventh symbols. At the head of each symbol, CP (Cyclic Prefix) is disposed.

The DMRS generator 107 and the DMRS sequence generator 106 will be discussed below. The DMRS sequence generator 106 generates a CAZAC (Constant Amplitude Zero Auto-Correlation) sequence r(n) corresponding to an assigned frequency bandwidth (the number of RBs (Resource Blocks) to be used, one RB being constituted by 12 subcarriers) by using assignment information included in the control information input from the control information obtaining unit 123. In this embodiment, as the CAZAC sequence, as in LTE, a Zadoff-Chu sequence r(n) having an index q, which is also used in the base station device 300, is generated. If the number of RBs to be used is three or more, the CAZAC sequence r(n) having a length M^{RS}_{sc} is defined by equation (1). M^{RS}_{sc} denotes a value obtained by multiplying the number of assigned RBs by the number of subcarriers forming one RB, which is 12. The number of assigned RBs is obtained by extracting information indicating RBs assigned to the terminal device 100 from the assignment information supplied from the control information obtaining unit 123. In equation (1), X_{q}(m) denotes a Zadoff-Chu sequence having an index q and is expressed by equation (2).

$$[ Math . 1 ]$$

$$\begin{matrix}r ( n ) = {x}_{q} ( n mod {N}_{ZC}^{RS} ) , 0 \leq n \leq {M}_{sc}^{RS} - 1 \\ [ Math . 2 ] & ( 1 ) \\ {x}_{q} ( m ) = exp ( - j \frac{π qm ( m + 1 )}{{N}_{ZC}^{RS}} ) , 0 \leq m \leq {N}_{ZC}^{RS} - 1 & ( 2 )\end{matrix}$$

N^{RS}_{ZC} denotes a maximum prime number which does not exceed M^{RS}_{sc}, and q is an index generated by the terminal device 100, by considering randomization of interference from adjacent cells, on the basis of information supplied from the base station device 300. Sequences other than Zadoff-Chu sequences, for example, other CAZAC sequences, such as Frank sequences, and PN (Pseudorandom noise) sequences, Gold codes of pseudorandom sequences, are also applicable.

A sequence output from the DMRS sequence generator 106 is input into the DMRS generator 107. The DMRS generator will be discussed below. The DMRS generator 107 performs processing on the sequence output from the DMRS sequence generator 106 so that the base station device 300 can perform channel estimation for the individual layers, that is, the base station device 300 can perform orthogonal code separation.

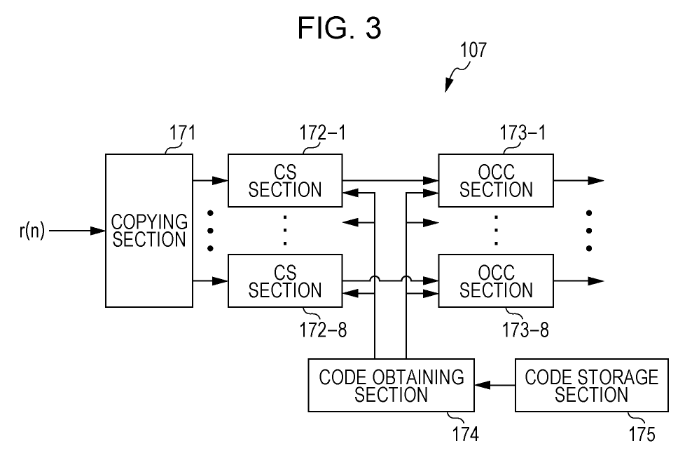

FIG. 3 is a schematic block diagram illustrating the configuration of the DMRS generator 107 according to this embodiment. The DMRS generator 107 includes a copying section 171, eight CS (Cyclic Shift) sections 172-1 through 172-8, eight OCC (Orthogonal Cover Code) sections 173-1 through 173-8, a code obtaining section 174, and a code storage section 175. The sequence r(n) input from the DMRS sequence generator 106 is input into the copying section 171. The copying section 171 copies the sequence r(n) by the same number as the number L of layers (ranks or streams), and outputs the copied sequence r(n) to the CS sections 172-1 through 172-L. If the number L of layers is less than eight, the CS sections 172-L+1 through 172-8 into which the sequence r(n) is not input and the associated OCC sections 173-L+1 through 173-8 are not operated.

The code storage section 175 stores, as assignment rules concerning the assignment of codes to reference signals, eight CSI=‘000’ through ‘111’ specified by the CSI information, n_{DMRS}⁽²⁾ which specifies a cyclic shift amount for each layer, an OCC (Orthogonal Cover Code) pattern for each layer in association with each other. The code obtaining section 174 reads n_{DMRS}⁽²⁾ corresponding to the CSI information obtained by the control information obtaining section 123 from the code storage section 175, and specifies cyclic shift amounts in the CS sections 172-1 through 172-8 on the basis of the read n_{DMRS}⁽²⁾ values. The code obtaining section 174 also reads OCC patterns corresponding to the CSI information from the code storage section 175, and specifies the OCC patterns in the OCC sections 173-1 through 173-8.

The CS sections 172-1 through 172-8 each utilize a CS (cyclic shift) amount specified by the code obtaining section 174. In this embodiment, as in LTE, a cyclic shift α is applied to the sequence r(n), as expressed by equation (3).

[Math. 3]

r^{(α)}(n)=e^{jαn}r(n) (3)

In equation (3), α is a value specified by the code obtaining section 174. The code obtaining section 174 calculates α according to equation (4) by using n_{DMRS}⁽²⁾ read from the code storage section 175.

In equation (4), K is a common value used in all terminal devices within a cell (sector).

[Math. 4]

α=2π((n_{DMRS}⁽²⁾+K)mod 12)/12 (4)

The CS sections 172-1 through 172-8 output r^{(α)}(n) to which the cyclic shift is applied to r(n) to the OCC sections 173-1 through 173-8, respectively. The OCC sections 173-1 through 173-8 each apply an orthogonal cover code (OCC) of an OCC pattern specified by the code obtaining section 174 to the input sequence r^{(α)}(n). That is, the OCC sections 173-1 through 173-8 each generate two DMRSs for #4 and #11 SC-FDMA symbols within the subframe shown in FIG. 27. For example, if the OCC pattern specified by the code obtaining section 174 is [+1, −1], the OCC section 173-1 sets the input sequence r^{(α)}(n) to be [r^{(α)}(n), −r^{(α)}(n)], and outputs [r^{(α)}(n), −r^{(α)}(n)] to the DMRS multiplexer 105-1 shown in FIG. 2. In [r^{(α)}(n), −r^{(α)}(n)], the first element r^{(α)}(n) is DMRS for the #4 SC-FDMA symbol and the second element −r^{(α)}(n) is DMRS for the #11 SC-FDMA symbol.

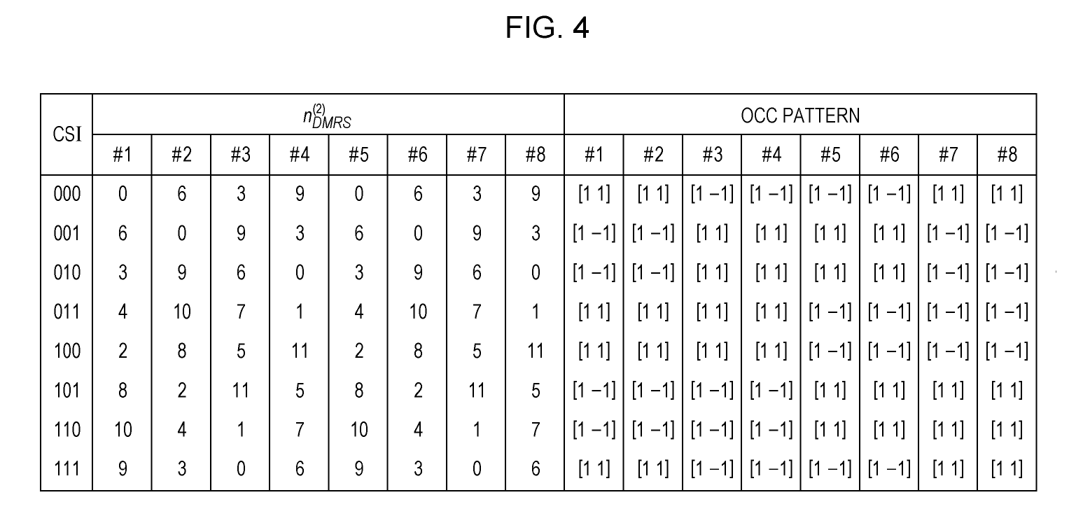

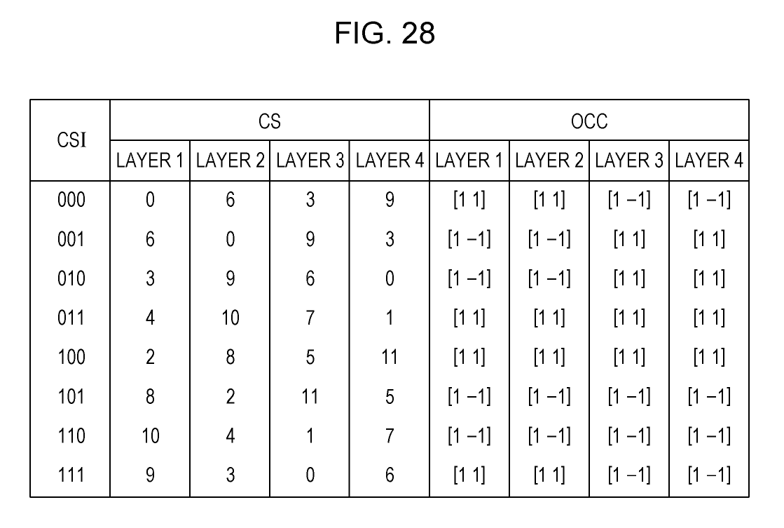

FIG. 4 illustrates a table showing an example of codes stored in the code storage section 175 according to this embodiment. LTE Rel-10 handles the number of layers only up to four layers. Accordingly, FIG. 4 shows an extended version of the table indicating codes used in LTE Rel-10 shown in FIG. 28. In FIG. 4, the number of columns of the table is twice as many as that of the table of FIG. 27, and SU-MIMO utilizing more than four layers can be performed.

The n_{DMRS}⁽²⁾ values and the OCC patterns for the layer #1 through the layer #4 shown in FIG. 4 are the same as those of the table used in LTE Rel-10 shown in FIG. 28. Moreover, n_{DMRS}⁽²⁾ values for the layer #1 through the layer #4 are applied to n_{DMRS}⁽²⁾ values for the layer #5 through the layer #8, respectively. That is, when p is set to be 1≦p≦4, it is assumed that “n_{DMRS}⁽²⁾ for the layer #p=n_{DMRS}⁽²⁾ for the layer #(p+4)”. Since the same n_{DMRS}⁽²⁾ value is used for the layer #p and the layer #(p+4) in FIG. 4, the base station device 300 is unable to separate DMRS of the layer #p and DMRS of the layer #(p+4) on the basis of the cyclic shift. Accordingly, concerning the OCC patterns for the layer #5 through the layer #8, patterns orthogonal (opposite) to those of n_{DMRS}⁽²⁾ for the layer #1 through the layer #4, respectively, are used. For example, when CSI is ‘011’, the OCC pattern for the layer #3 is [1, 1], and thus, the OCC pattern for the layer #7 is [1, −1]. That is, when p is set to be 1≦p≦4, it is assumed that “when the OCC pattern for the layer #p is [1, 1], the OCC pattern for the layer #(p+4) is [1, −1]” and that “when the OCC pattern for the layer #p is [1, −1], the OCC pattern for the layer #(p+4) is [1, 1]”.

That is, the table shown in FIG. 4 indicates that the terminal device 100 generates the following demodulation reference signals. Orthogonal codes, that is, a code for one layer and a code for another layer are orthogonal to each other, are assigned to reference signals, and concerning layers up to a predetermined number (“4”) of layers, codes are assigned to the reference signals according to the same assignment rules as those used in the terminal device 200.

In this manner, a table is created such that, for two layers using the same n_{DMRS}⁽²⁾ values, opposite OCC patterns are assigned. With this configuration, by using this table, a reception side is able to separate DMRSs for a maximum of eight layers. Additionally, the configuration of the table shown in FIG. 4 concerning first four layers has the same configuration as that of Rel-10, thereby making it possible to maintain the backward compatibility. For example, MU-MIMO performed by the terminal device 100 or 200 which generates DMRSs with CSI=‘100’ and which performs SU-MIMO using four layers and the terminal device 100 or 200 which generates DMRSs with CSI=‘101’ and which performs SU-MIMO using four layers is implemented in a manner similar to Rel-10.

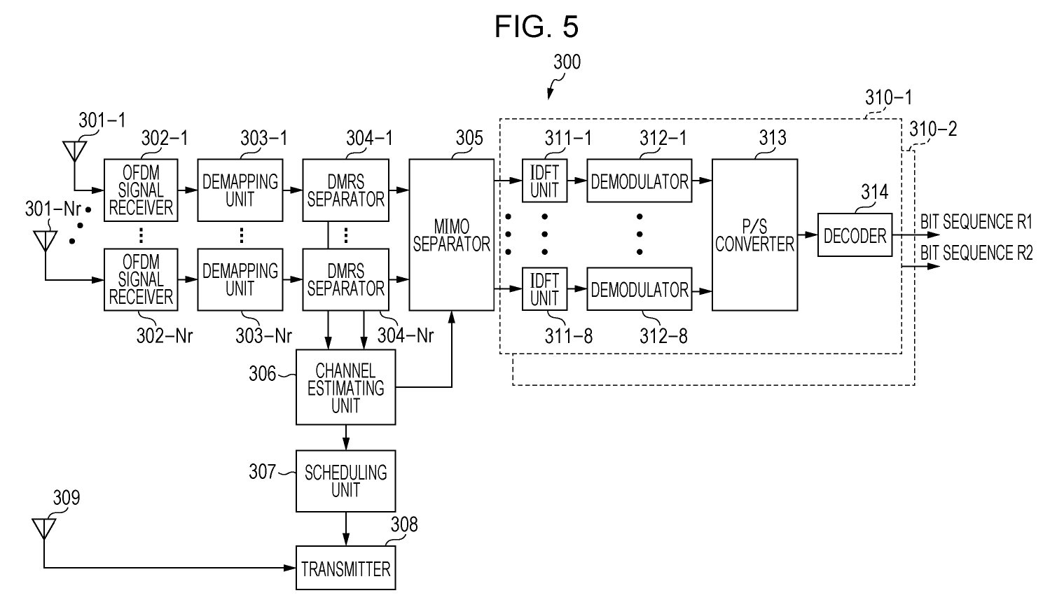

FIG. 5 is a schematic block diagram illustrating the configuration of the base station device 300 according to this embodiment. The base station device 300 includes Nr reception antennas 301-1 through 301-Nr, Nr OFDM signal receivers 302-1 through 302-Nr, Nr demapping units 303-1 through 303-Nr, Nr DMRS separators 304-1 through 304-Nr, an MIMO separator 305, a channel estimating unit 306, a scheduling unit 307, a transmitter 308, a transmission antenna 309, and two terminal signal processors 310-1 and 310-2. In this embodiment, a description will be given, assuming that two terminal signal processors are provided by considering that MU-MIMO is performed by two users. However, if MU-MIMO is performed by more users, the same number of terminal signal processors as the number of users is provided. The terminal signal processors 310-1 and 310-2 each include eight IDFT units 311-1 through 311-8, eight demodulators 312-1 through 312-8, a P/S converter 313, and a decoder 314.

Signals transmitted from the terminal devices 100 and 200 are received by the Nr reception antennas 301-1 through 301-Nr of the base station device 300 shown in FIG. 5 via wireless channels. The signals received by the reception antennas 301-1 through 301-Nr are respectively input into the OFDM signal receivers 302-1 through 302-Nr connected to the associated reception antennas. The OFDM signal receivers 302-1 through 302-Nr each perform processing, such as down-conversion to a baseband, analog filtering, and A/D (analog-to-digital) conversion, and then removes CP added by the terminal devices 100 and 200 from the signals and performs FFT (Fast Fourier Transform). The OFDM signal receivers 302-1 through 302-Nr then output frequency domain signals generated by the above-described conversion to the demapping units 303-1 through 303-Nr connected to the OFDM signal receivers 302-1 through 302-Nr, respectively. The demapping units 303-1 through 303-Nr extract frequency domain signals of a frequency band used for communication, on the basis of assignment information generated by the scheduling unit 307. The frequency domain signals extracted by the demapping units 303-1 through 303-Nr are input into the DMRS separators 304-1 through 304-Nr, respectively.

The DMRS separators 304-1 through 304-Nr each separate, from a received signal, received DMRS symbols, which are the fourth and eleventh SC-FDMA symbols, included in each subframe shown in FIG. 27, and output the separated received DMRS symbols to the channel estimating unit 306 and output the other data symbols to the MIMO separator 305.

The channel estimating unit 306 estimates channels between the individual layers of each terminal device and the reception antennas 301-1 through 301-Nr, on the basis of the received DMRS symbols separated by the DMRS separators 302-1 through 302-Nr and assignment information and CSI information generated by the scheduling unit 307. Details of the channel estimating unit 306 will be discussed later. The scheduling unit 307 determines a precoding matrix, a frequency band, and codes for DMRSs used for transmission performed by each terminal device, on the basis of the results of channel estimation by the channel estimating unit 306. Then, scheduling unit 307 generates PMI information, assignment information, and CSI information. The transmitter 308 transmits control information including the CSI information, PMI information, and assignment information generated by the scheduling unit 307 to the terminal devices 100 and 200 via the transmission antenna 309.

Meanwhile, by using the inputs from the DMRS separators 304-1 through 304-Nr, the input from the channel estimating unit 306, and the assignment information generated by the scheduling unit 307, the MIMO separator 305 separates the inputs into frequency domain signals of layers assigned to each of the terminal device 100 and the terminal device 200. In this case, any separation technique, such as spatial filtering (for example, ZF (Zero Forcing) or MMSE (Minimum Mean Square Error)), SIC (Successive Interference Cancellation), V-BLAST (Vertical Bell Laboratories Layered Space Time), may be employed.

The separated frequency domain signals of the individual layers are input into the associated IDFT units 311-1 through 311-8 of each of the terminal signal processors 310-1 and 310-2. That is, among the IDFT units 311-1 through 311-8 of the terminal signal processor 310-1, the signals of the individual layers of the terminal device 100 are input into the IDFT units 311 having the same branch numbers of the reference numeral of the IDFT units 311 as the layer numbers of the layers, such as the signal of the layer #1 of the terminal device 100 is input into the IDFT unit 311-1 of the terminal signal processor 310-1, the signal of the layer #2 of the terminal device 100 is input into the IDFT unit 311-2 of the terminal signal processor 310-1, and so on. Similarly, among the IDFT units 311-1 through 311-8 of the terminal signal processor 310-2, the signals of the individual layers of the terminal device 200 are input into the IDFT units 311 having the same branch numbers of the reference numeral of the IDFT units 311 as the layer numbers of the layers, such as the signal of the layer #1 of the terminal device 200 is input into the IDFT unit 311-1 of the terminal signal processor 310-2, the signal of the layer #2 of the terminal device 200 is input into the IDFT unit 311-2 of the terminal signal processor 310-2, and so on.

The IDFT units 311-1 through 311-8 perform Inverse Discrete Fourier Transform on the received frequency domain signals so as to transform the received frequency domain signals into time domain signals. The demodulators 312-1 through 312-8 convert the obtained time domain signals into bits. The P/S converter 313 performs parallel-to-serial conversion on the bits generated by the demodulators 312-1 through 312-8. The decoder 314 applies error-correcting decoding to a bit string converted by the P/S converter 313. Then, the decoder 314 of the terminal signal processor 310-1 obtains a bit sequence R1 transmitted from the terminal device 100, while the decoder 314 of the terminal signal processor 310-2 obtains a bit sequence R2 transmitted from the terminal device 200.

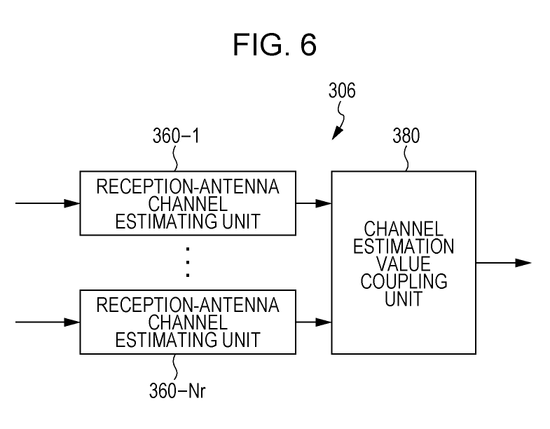

FIG. 6 is a schematic block diagram illustrating the configuration of the channel estimating unit 306 according to this embodiment. The channel estimating unit 306 includes Nr reception-antenna channel estimating units 360-1 through 360-Nr and a channel estimation value coupling unit 380. The reception-antenna channel estimating units 360-1 through 360-Nr each estimate channels between the layers of each of the terminal devices 100 and 200 and the associated reception antennas.

That is, DRMS symbols received from the DMRS separators 302-1 through 302-Nr are input into the reception-antenna channel estimating units 360-1 through 360-Nr, respectively. The reception-antenna channel estimating units 360-1 through 360-Nr each estimate channels of the individual layers and calculate channel estimation value vectors (1×the total number of layers) having channel estimation values of the individual layers as elements, and then output the calculated channel estimation value vectors to the channel estimation value coupling unit 380. (1×the total number of layers) means that the size of the vectors is equal to a matrix of 1×the total number of layers. Details of each of the reception-antenna channel estimating units 360-1 through 360-Nr will be discussed later. The channel estimation value coupling unit 380 couples the channel estimation value vectors (1×L) input from the reception-antenna channel estimating units 360-1 through 360-Nr, and calculates a channel estimation value matrix (Nᵣ×L) by using equation (5), and then outputs the calculated channel estimation value matrix to the MIMO separator 305.

$$[ Math . 5 ]$$

$$\hat{H} = [ \begin{matrix}{\hat{H}}_{1} \\ {\hat{H}}_{2} \\ ⋮ \\ {\hat{H}}_{{N}_{r}}\end{matrix} ] \qquad ( 5 )$$

where Ĥₘ is a channel estimation value estimated by the reception-antenna channel estimating unit 360-m.

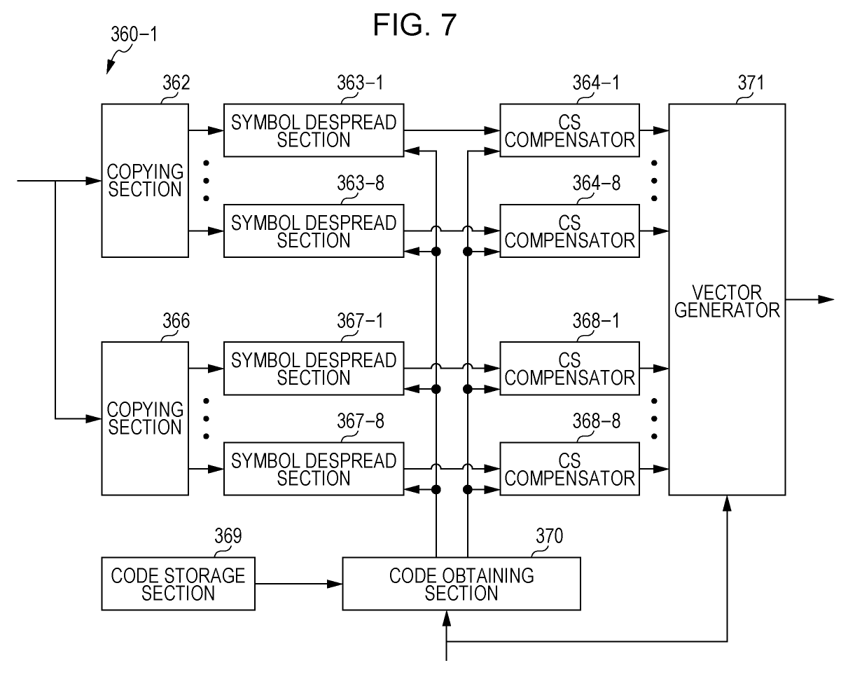

FIG. 7 is a schematic block diagram illustrating the configuration of the reception-antenna channel estimating unit 360-1 according to this embodiment. The configurations of the other reception-antenna channel estimating units 360-2 through 360-Nr are similar to the configuration of the reception-antenna channel estimating unit 360-1, and an explanation thereof will thus be omitted. The reception-antenna channel estimating unit 360-1 includes a copying section 362, eight symbol despread sections 363-1 through 363-8, eight CS compensators 364-1 through 364-8, a copying section 366, eight symbol despread sections 367-1 through 367-8, eight CS compensators 368-1 through 368-8, a code storage section 369, a code obtaining section 370, and a vector generator 371.

Vectors Rₘ(1×2) of received DRMS symbols constituted by SC-FDMA symbols #4 and #11 included in a signal received by the reception antenna 301-1 are input into the reception-antenna channel estimating unit 360-1. The copying section 362 generates eight copies of the input vectors, and outputs the copied vectors to the symbol despread sections 363-1 through 363-8.

The symbol despread sections 363-1 through 363-8 perform despread processing on the OCCs applied in the terminal device 100 in accordance with instructions from the code obtaining section 370. For example, the symbol despread sections 363-1 through 363-8 each perform despread processing on a layer having the same layer number as the branch number of the symbol despread section 363, such as the symbol despread section 363-1 performs despread processing on the layer #1, the symbol despread section 363-2 performs despread processing on the layer #2, and so on. For example, a case in which the scheduling section 307 has assigned CSI=‘111’ and seven layers to the terminal device 100 will be considered. In this case, the code obtaining section 370 supplies information concerning CSI=‘111’ and [1, −1], which is the OCC pattern of the layer #5, to the symbol despread section 363-5 (see FIG. 4). The symbol despread section 363-5 multiplies the input vectors Rₘ by [1, −1] according to equation (6) on the basis of the received information.

[Math. 6]

Rₘ^{OCC}(n)=[1 −1]Rₘ^{T} (6)

In the case of low mobility, that is, when time fluctuations in channels can be ignored, received DMRS symbols are subjected to despread processing in the above-described manner, thereby making it possible to orthogonalize received DMRS for a layer using [1, 1] as the OCC pattern. That is, although the n_{DMRS}⁽²⁾ value of a layer #p coincides with that of a layer #(p+4), OCC patterns of the layer #p and the layer #(p+4) are different. Accordingly, it is possible to separate DMRS for the layer #p and that for the layer #(p+4) from each other. Outputs from the symbol despread sections 363-1 through 363-8 are input into the CS compensators 364-1 through 364-8, respectively.

The CS compensators 364-1 through 364-8 each perform processing for compensating for CS applied in the terminal device 100, that is, the CS compensators 364-1 through 364-8 each perform despread processing in the frequency direction, in accordance with instructions from the code obtaining section 370. That is, the CS compensators 364-1 through 364-8 first each multiply the frequency spectrum Rₘ^{OCC}(n), which is input from the associated symbol despread sections 363-1 through 363-8, by the cyclic shift a corresponding to the associated layer. That is, the CS compensators 364-1 through 364-8 perform processing expressed by equation (7).

[Math. 7]

exp(−jαn)r*(n)Rₘ^{OCC}(n) (7)

In this case, in order to compensate for phase rotation performed by a transmission signal itself, the CS compensators 364-1 through 364-8 multiply the frequency spectrum Rₘ^{OCC}(n) also by a complex conjugate r*(n) of a DMRS sequence r(n). The DMRS sequence r(n) is input from the code obtaining section 370.

Then, in order to orthogonalize layers multiplexed with another cyclic shift, the CS compensators 364-1 through 364-8 each average the calculation results of equation (7) by using four adjacent frequency points, and output the obtained signal to the vector generator 371. In this manner, DMRSs transmitted for other layers can be orthogonalized. If the number of multiplexed layers using the same OCC pattern is two, averaging using two adjacent frequency points may be performed. If the number of multiplexed layers using the same OCC pattern is one, averaging using adjacent frequency points is not necessarily performed. For example, a case in which CSI is ‘100’ and the number of layer is six will be discussed. In this case, as shown in FIG. 4, the layer #1 through the layer #4 are multiplexed by using the OCC pattern [1, 1]. Since the number of such multiplexed layers is four, averaging using four adjacent frequency points is performed. However, only the layer #5 and the layer #6 are multiplexed by using the OCC pattern [1, −1]. Since the number of such multiplexed layers is two, it is sufficient that averaging using two adjacent frequency points is performed.

The copying section 366, the eight symbol despread sections 367-1 through 367-8, and the eight CS compensators 368-1 through 368-8 are similar to the copying section 362, the eight symbol despread sections 363-1 through 363-8, and the eight CS compensators 364-1 through 368-4, respectively. However, the copying section 366, the symbol despread sections 367-1 through 367-8, and the CS compensators 368-1 through 368-8 are different from the counterparts in that they process a signal transmitted from the terminal device 200.

The code storage section 369 stores therein the table shown in FIG. 4, as in the code storage section 175 of the terminal device 100. The code obtaining section 370 reads CSI information generated by the scheduling unit 307 and n_{DMRS}⁽²⁾ values and OCC patterns used in the individual layers of each terminal device from the code storage section 369. The code obtaining section 370 also generates a DMRS sequence r(n) on the basis of input assignment information. The code obtaining section 370 calculates a cyclic shift a on the basis of the read n_{DMRS}⁽²⁾ values and outputs the calculated α and r(n) to corresponding CS compensators among the CS compensators 364-1 through 364-8 and 368-1 through 368-8. Similarly, the code obtaining section 370 outputs the read OCC patterns to corresponding symbol despread sections among the symbol despread sections 363-1 through 363-8 and 367-1 through 367-8. On the basis of the assignment information, the vector generator 371 extracts outputs, from among the outputs of the CS compensators 364-1 through 364-8 and 368-1 through 368-8, associated with the layers assigned to the terminal devices 100 and 200 so as to generate channel estimation value vectors (1×the total number of layers). The generated channel estimation value vectors are input into the channel estimation value coupling unit 380 shown in FIG. 6.

A description has been given of a technique for separating DMRSs by using CS in the frequency domain. However, separation of DMRSs may be performed in the time domain. For example, frequency domain signals input into the symbol despread sections 363-1 through 363-8 and 367-1 through 367-8 may be transformed into time domain signals. Then, since signals of the individual layers having different cyclic shifts have been transmitted, time-shifted responses can be observed. Then, the CS compensators 364-1 through 364-8 and 368-1 through 368-8 may extract desired impulse responses, and may transform the obtained impulse responses into frequency domain signals.

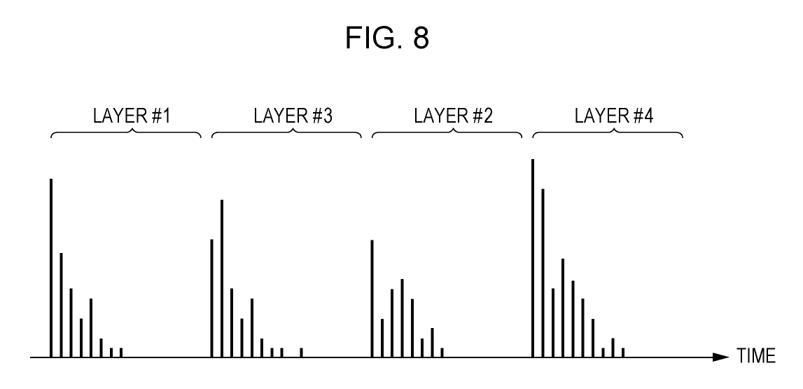

For example, when CSI is ‘100’ and the number of layers is six in FIG. 4, signals obtained by performing despread processing with the OCC pattern [1, 1] include DMRSs for the layer #1 through the layer #4. If the signals are transformed into time domain signals and impulse responses are calculated, time responses, such as those shown in FIG. 8, can be observed. The CS compensator 364-2 extracts an impulse response of the layer #2 from among the obtained time responses, transforms the extracted impulse response into a frequency domain signal, and then outputs the frequency domain signal to the vector generator 371.

According to this embodiment, in MIMO transmission using eight transmission antennas, the terminal device 100 is capable of performing transmission using five or more layers. In this case, since the table shown in FIG. 4 is utilized, the difference between an n_{DMRS}⁽²⁾ value of one layer and that of another layer is at least three, as in the specifications of Rel-10. Thus, it is possible to perform MIMO transmission using a maximum of eight layers while maintaining tolerance to frequency selective fading. Moreover, when the terminal device 100 performs transmission using one through four layers, it performs processing similar to that used in terminal devices of and before Rel-10, such as the terminal device 200, thereby making it possible to maintain the backward compatibility. That is, if the terminal device 100 performs transmission using up to four layers, it can perform MU-MIMO with a terminal device of Rel-8 or Rel-10, such as the terminal device 200. As a result, the throughput of the terminal device 100 and the cell throughput can be significantly improved.

In this embodiment, a system using eight transmission antennas has been discussed. This embodiment is also similarly applicable to a system having five or more transmission antennas.

### Second Embodiment

In this embodiment, the assignment of CS values and OCC patterns which implements MU-MIMO with a terminal using five or more layers will be discussed.

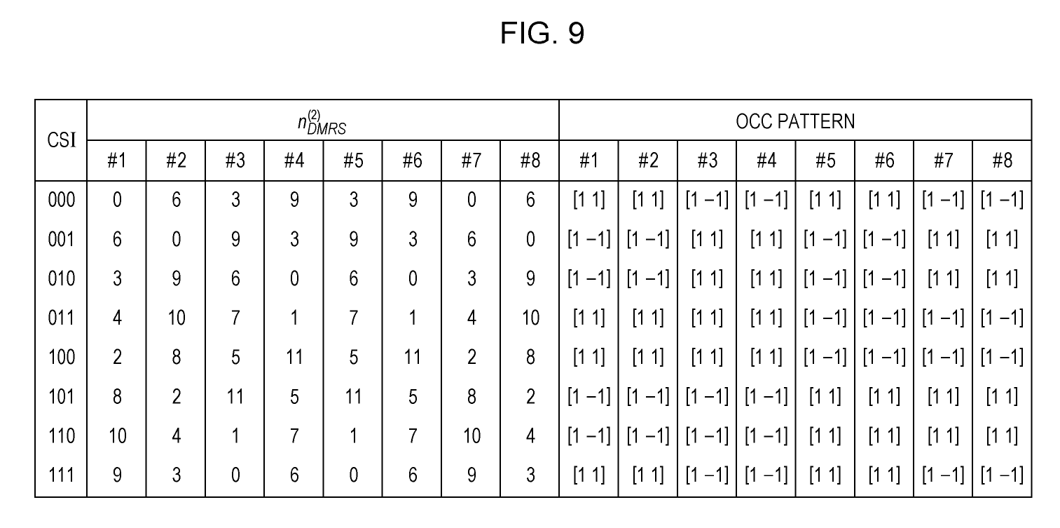

FIG. 9 illustrates a table showing an example of codes according to a second embodiment of the present invention.

The n_{DMRS}⁽²⁾ values and OCC patterns of the layer #1 through the layer #4 shown in FIG. 9 are the same as those indicated in the table of LTE Rel-10 shown in FIG. 28. The n_{DMRS}⁽²⁾ values of the layer #3 and the layer #4 are applied to those of the layer #5 and the layer #6. The n_{DMRS}⁽²⁾ values of the layer #1 and the layer #2 are applied to those of the layer #7 and the layer #8. Concerning the OCC patterns, the OCC patterns of the layer #1 through the layer #4 are the same as those of the layer #5 through the layer #8, respectively.

If a combination of n_{DMRS}⁽²⁾ values of the layer #1 and the layer #2 of a certain CSI is the same as a combination of n_{DMRS}⁽²⁾ values of the layer #7 and the layer #8 of another CSI, the same OCC pattern is used for such layers. That is, if a combination of n_{DMRS}⁽²⁾ values of layer numbers greater than a predetermined value L1 (in this embodiment, L1=6) is the same as a combination of n_{DMRS}⁽²⁾ values of layer numbers smaller than L3 (L3≦L2=the maximum number of layers −L1) of another CSI, the same OCC pattern is used for such layers.

For example, since the OCC pattern of the layer #7 and the layer #8 of CSI=‘000’ (the combination of n_{DMRS}⁽²⁾ is 0, 6) is [1, −1], the OCC pattern of the layer #1 and the layer #2 of CSI=‘001’ (the combination of n_{DMRS}⁽²⁾ is 0, 6) is also [1, −1].

The table shown in FIG. 9 is a table generated by a table generator in the following manner. This table generator may be included in a terminal device which performs wireless communication or in another device.

The table generator first searches the Rel-10 table shown in FIG. 28 for two CSIs having the same combination of n_{DMRS}⁽²⁾ values of the layer 1 and the layer 2, and forms extracted CSIs as a pair. For example, for both CSI=‘000’ and CSI=‘001’, 0 and 6 are used as the n_{DMRS}⁽²⁾ values of the layer 1 and the layer 2, and thus, CSI=‘000’ and CSI=‘001’ are paired. In this manner, CSI=‘010’ and CSI=‘111’, CSI=‘011’ and CSI=‘110’, and CSI=‘100’ and CSI=‘101’ are also paired. This operation will be discussed below by taking CSI=‘000’ and CSI=‘001’ as an example.

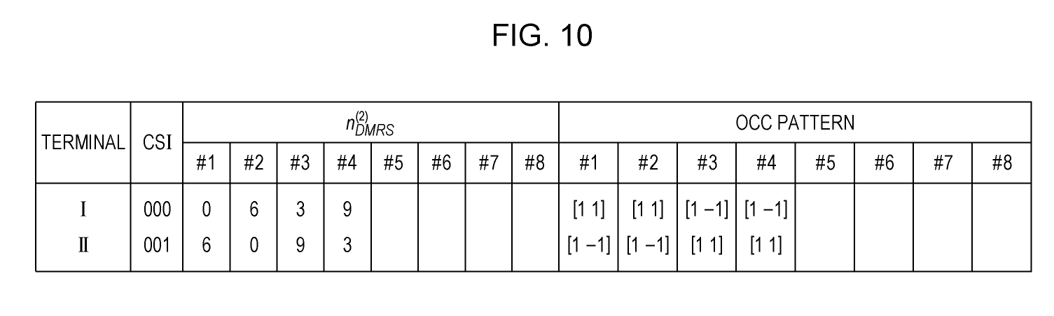

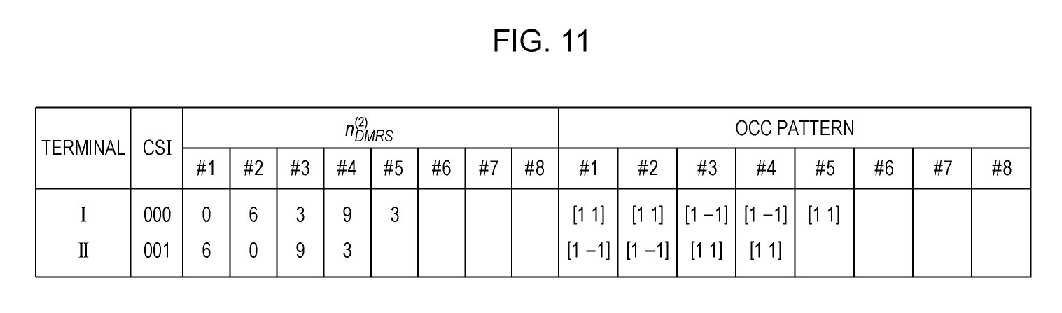

The table generator inputs extracted values into the table, as shown in FIG. 10. Columns associated with the layer 5 through the layer 8 are kept blank. Inputting of extracted values into the columns of CSI=‘000’ will be discussed. Since the maximum number of layers is eight, if a terminal device associated with CSI=‘000’ (hereinafter called a “terminal device 1”) performs transmission using five layers, a terminal device associated with CSI=‘001’ (hereinafter called a “terminal device 2”) can participate in MU-MIMO if it performs transmission using up to three layers. That is, the CS value and the OCC pattern for the layer 4 of the terminal device 2 are not used for the terminal device 2. Accordingly, the table generator utilizes a combination of the CS value and the OCC pattern for the layer 4 of the terminal device 2 for the layer 5 of the terminal device 1, as shown in FIG. 11. By assigning CS values and OCC patterns in this manner, it is possible to implement MU-MIMO by using the terminal device 1 which performs transmission using five layers and the terminal device 2 which performs transmission using up to three (or less) layers.

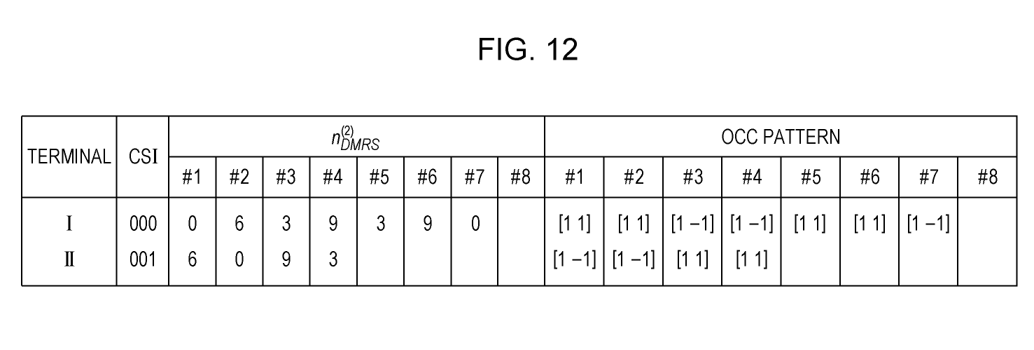

If the terminal device 1 performs transmission using six layers, the terminal device 2 can participate in MU-MIMO if it performs transmission using up to two layers. That is, the CS values and OCC patterns for the layer 3 and the layer 4 of the terminal device 2 are not used for the terminal device 2. Accordingly, since a combination of the CS value and OCC pattern for the layer 4 of the terminal device 2 has already been utilized for the layer 5 of the terminal device 1, the table generator utilizes a combination of the CS value and the OCC pattern for the layer 3 of the terminal device 2 for the layer 6 of the terminal device 1. Similarly, the table generator determines a combination of a CS value and an OCC pattern for the layer 7 of the terminal device 1, thereby obtaining a table shown in FIG. 12.

Concerning the layer 8, by considering the separation performance of SU-MIMO, the table generator utilizes a combination of the CS value and the OCC pattern for the layer 1 of the terminal device 2 which is not being used. In this manner, a table concerning the terminal device 1 (that is, CSI=‘000’) can be created. The table generator performs similar processing for other CSIs, thereby creating the table shown in FIG. 9.

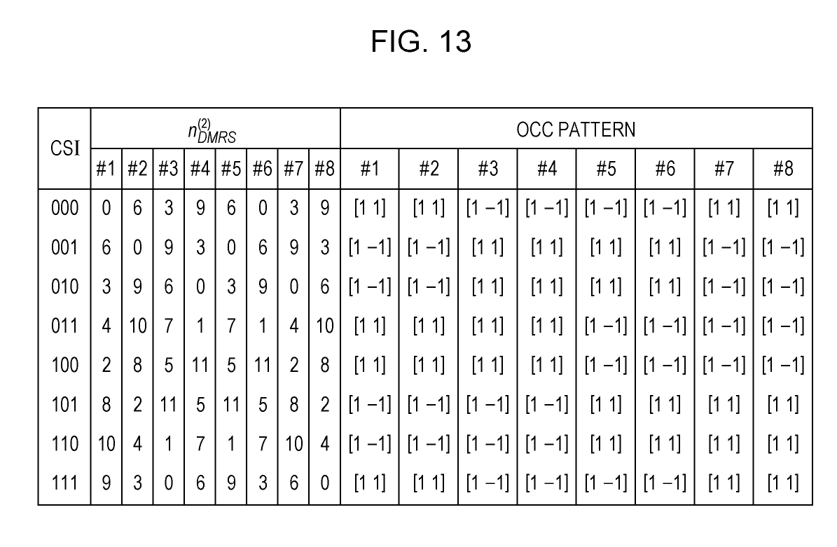

In the above-described example, the table generator pairs CSI=‘000’ with CSI=‘001’, but may pair CSI=‘000’ with CSI=‘111’. In this case, CSI=‘001’ pairs with CSI=‘010’. In such a case, if a table is created according to the above-described flow, the table shown in FIG. 13 can be created.

However, the table generator dose not pair CSI=‘000’ with CSI=‘010’. This is because it is not possible to perform MU-MIMO by utilizing a terminal device using four layers and a terminal device using four layers, which is validated by the fact that, for example, the CS value and the OCC pattern assigned to the layer 1 of CSI=‘000’ coincide with those assigned to the layer 4 of CSI=‘000’.

The terminal device of this embodiment is the same as the terminal device 100, except that the code storage section 175 stores the table shown in FIG. 9.

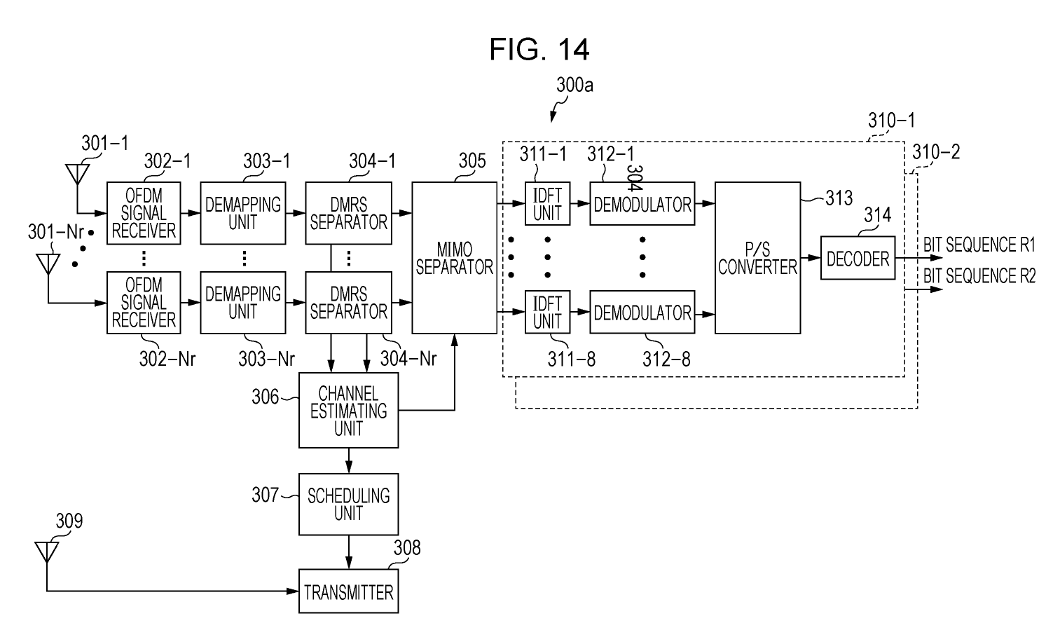

FIG. 14 is a schematic block diagram illustrating the configuration of a base station device 300a according to this embodiment.

The base station device 300a is different from the base station device 300 (FIG. 5) in that a scheduling unit 307a is provided. Functions of elements designated by the same reference numerals as those of the base station device 300 are similar to the functions of the elements of the base station device 300, and an explanation thereof will thus be omitted. The code storage section 369 of the reception-antenna channel estimating unit (see FIG. 6) used in the channel estimating unit 306 stores therein the table shown in FIG. 9.

The scheduling unit 307a has functions similar to those of the scheduling unit 307 (FIG. 5) of the first embodiment. The scheduling unit 307a assigns paired CSIs to two terminal devices which perform MU-MIMO and generates CSI information concerning the CSIs. For example, the scheduling unit 307a calculates a total number of layers used in a plurality of terminal devices which perform MU-MIMO, and determines whether the total value is eight or smaller. If the total value is eight or smaller, the scheduling unit 307a determines that it is possible to perform MU-MIMO, and generates CSI information. If the total value exceeds eight, the scheduling unit 307a may reject communication with one terminal device (for example, a terminal device using a smaller number of layers), or may assign such a terminal device to another frequency. The scheduling unit 307a may also hand over such a terminal device to another base station device.

The DMRS generator 107 of the terminal device 1 and the DMRS generator 107 (see FIG. 2) of the terminal device 2 may generate DMRSs on the basis of CSI information supplied from the base station device, as in the first embodiment.

This embodiment is applicable to a case in which, in MIMO transmission using eight transmission antennas, transmission using five or more layers is performed. Reference signals based on the table shown in FIG. 9 are codes which make it possible to increase the number of layers in the following manner. A maximum total number of transmission layers when MU-MIMO for multiplexing signals of two terminal devices of this embodiment is performed and a maximum total number of transmission layers when MU-MIMO for multiplexing a signal of the terminal device of this embodiment and a signal of a REl-10 terminal device is performed is twice (that is, “eight”) as many as a maximum total number of transmission layers when SU-MIMO is performed by a Rel-10 terminal device. Accordingly, by the use of the table shown in FIG. 9, the difference between an n_{DMRS}⁽²⁾ value of one layer and that of another layer is at least three, as in the specifications of Rel-10. Thus, it is possible to perform MIMO transmission using a maximum of eight layers while maintaining tolerance to frequency selective fading. Moreover, when performing transmission using up to four layers, processing similar to that used in terminal devices of and before Rel-10 is performed, thereby making it possible to maintain the backward compatibility. That is, it is possible to perform MU-MIMO with a terminal device of Rel-8 or Rel-10. It is also possible to perform MU-MIMO by a terminal using five or more layers of this embodiment and a terminal of or before Rel-10. Thus, the throughput can be significantly improved.

### Third Embodiment

In this embodiment, a terminal device performs MU-MIMO with a terminal device which performs SU-MIMO using five or more layers, by utilizing a band which is not the same band as the SU-MIMO terminal device.

In Rel-10, OCC patterns having a spreading factor of 2 are applied by using two DMRSs in one subframe. In this embodiment, however, two subframes are grouped, and OCC patterns having a spreading factor of 4 are applied by using four DMRSs.

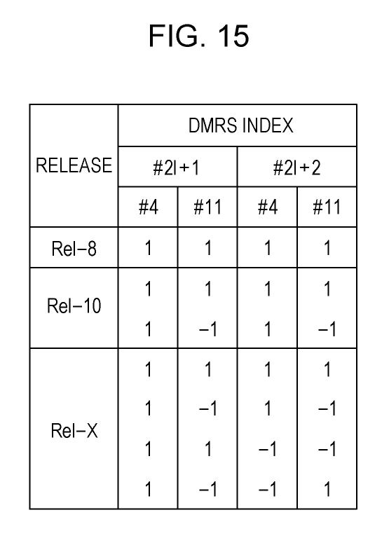

FIG. 15 illustrates a table showing an example of DMRS indexes. In this table, a DMRS index is associated with each release. In this table, Rel-X indicates this embodiment, and I denotes an integer of 0 or greater.

In Rel-8, it can be assumed that 1 is always multiplied as an OCC pattern. In Rel-10, as OCC, SC-FDMA symbol #4 is always multiplied by 1 and SC-FDMA symbol #11 is multiplied by 1 or −1 on the basis of CSI supplied from a base station device. In contrast, in this embodiment (Rel-X), for a (2I+1)-th subframe, codes similar to those of Rel-10 are multiplied, that is, SC-FDMA symbol #4 is always multiplied by 1 and SC-FDMA symbol #11 is multiplied by 1 or −1 on the basis of CSI supplied from a base station device. In this embodiment, however, for a (2I+2)-th subframe, SC-FDMA symbol #4 is also multiplied by 1 or −1 on the basis of CSI supplied from a base station device. SC-FDMA #11 is processed in a similar manner. Walsh codes having a spreading factor of 4 are applied by using four DMRSs. Accordingly, the DMRS generator generates four DMRSs and inputs the four DMRSs to the DMRS multiplexer.

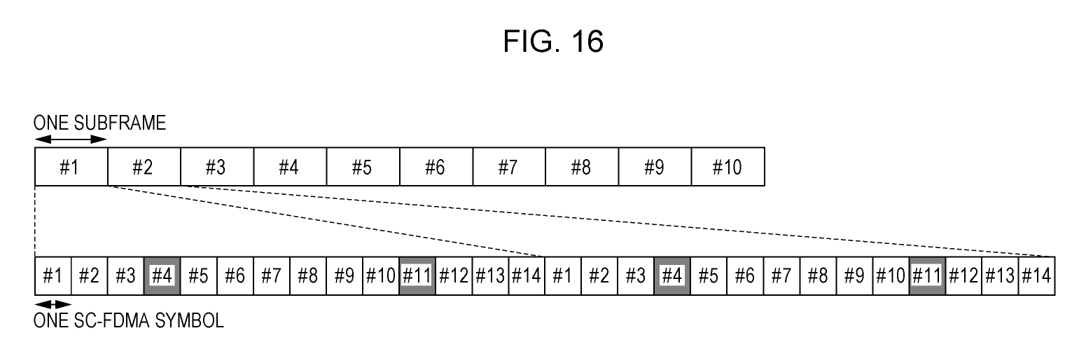

A terminal device 100b according to this embodiment multiplexes four DMRSs in two subframes, as shown in FIG. 16. The length of Walsh codes is restricted to a power of two, and thus, 8, 16, 32, and so on may be considered in addition to 4. However, the frame configuration of PUSCH of LTE is such that one frame is constituted by 10 subframes, and each subframe contains two DMRSs, as shown in FIG. 16. Accordingly, the number of DMRSs within one frame is 20. Since the divisors of 20 are 1, 2, 4, 5, 10, and 20, it is not possible to assign Walsh codes having a spreading factor of 8 or 16 to one frame. That is, as an extended version of Walsh codes having a spreading factor of two of Rel-10, not all types of Walsh codes having any spreading factor can be used, but Walsh codes having a spreading factor of 4 should be used.

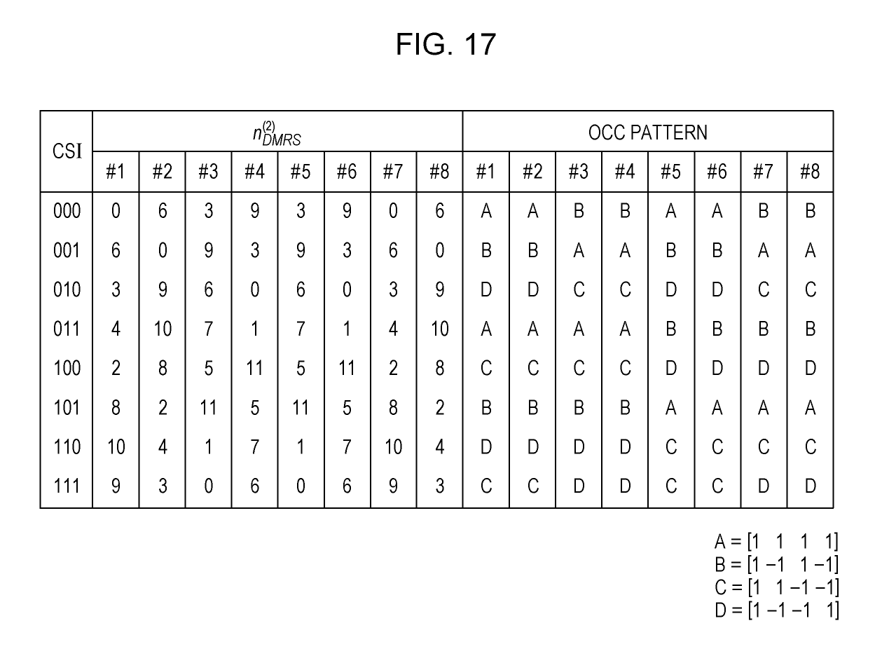

A description will now be given of a table for generating four DMRSs in the DMRS generator. FIG. 17 illustrates a table showing an example of codes according to a third embodiment.

A, B, C, and D in FIG. 9 denote [+1, +1, +1, +1], [+1, −1, +1, −1], [+1, +1, −1, −1], and [+1, −1, −1, +1], respectively (in the drawing, the sign “+” is not shown). Numerical values within brackets indicate that the first and second values are respectively used for generating #4 and #11 SC-FDMA symbols within a (2I+1)-th subframe and the third and fourth values are respectively used for #4 and #11 SC-FDMA symbols within a (2I+2)-th subframe.

The n_{DMRS}⁽²⁾ values of the layer #3 and the layer #4 are applied to the n_{DMRS}⁽²⁾ values of the layer #5 and the layer #6, respectively. The n_{DMRS}⁽²⁾ values of the layer #1 and the layer #2 are applied to the n_{DMRS}⁽²⁾ values of the layer #7 and the layer #8, respectively. Concerning the OCC patterns, patterns used for n_{DMRS}⁽²⁾ of the layer #1 through the layer #4 are opposite (orthogonal) to the layer #5 through the layer #8.

If a combination of n_{DMRS}⁽²⁾ values of the layer #1 and the layer #2 of a certain CSI is the same as a combination of n_{DMRS}⁽²⁾ values of the layer #7 and the layer #8 of another CSI, the same OCC pattern is used for these combinations.

The table shown in FIG. 17 is a table generated by a table generator in the following manner. This table generator may be included in a terminal device which performs wireless communication or in another device. Since the backward compatibility is maintained in the table shown in FIG. 17, an example of an extended version of this table will be discussed in this embodiment. As long as OCC patterns are applied by using four DMRSs, numerical values within the table are not restricted to those shown in FIG. 17.

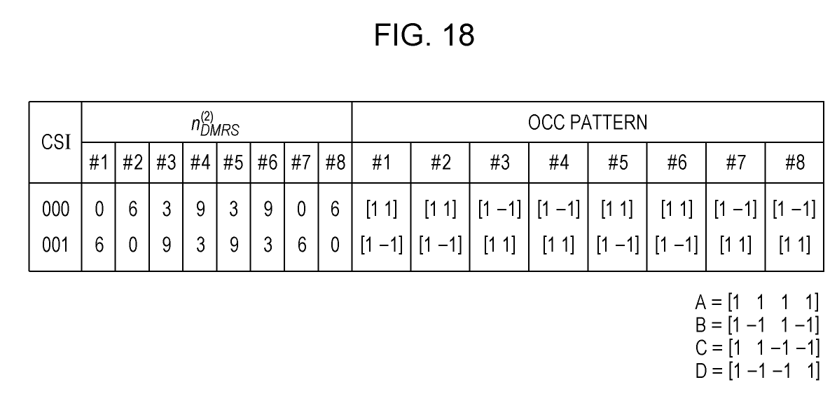

Codes concerning CSI=‘000’ and CSI=‘001’ extracted from the table of the second embodiment (FIG. 9) are shown in FIG. 18. The table generator defines Walsh codes having a spreading factor of 4 as A=[1, 1, 1, 1], B=[1, −1, 1, −1], C=[1, 1, −1, −1], and D=[1, −1, −1, 1]. Concerning CS, in order to maintain tolerance to frequency selective fading, CS values similar to those of the second embodiment are used.

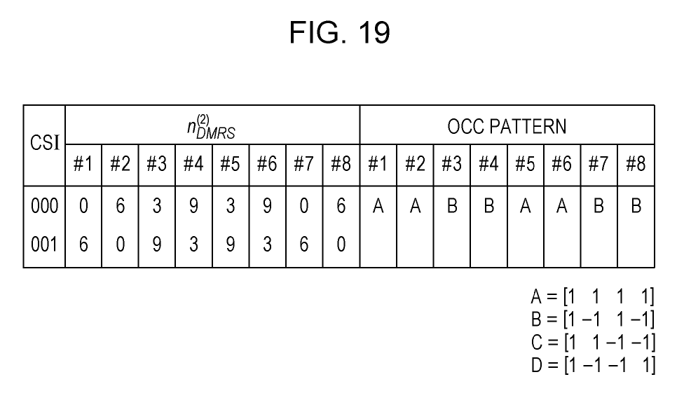

Since the OCC pattern for the layer 1 and the layer 2 of CSI=‘000’ is [1, 1], the table generator equally assigns A to both the layer 1 and the layer 2 in the table for Rel-X. Since, in FIG. 18, the OCC pattern for the layer 3 and the layer 4 of CSI=‘000’ is [1, −1], which is different from the pattern of the layer 1 and the layer 2, the table generator equally assigns B to both the layer 3 and the layer 4 in the table for Rel-X. The table generator assigns OCC patterns to the layer 5 through the layer 8 in a similar manner. As a result, the table shown in FIG. 19 is obtained.

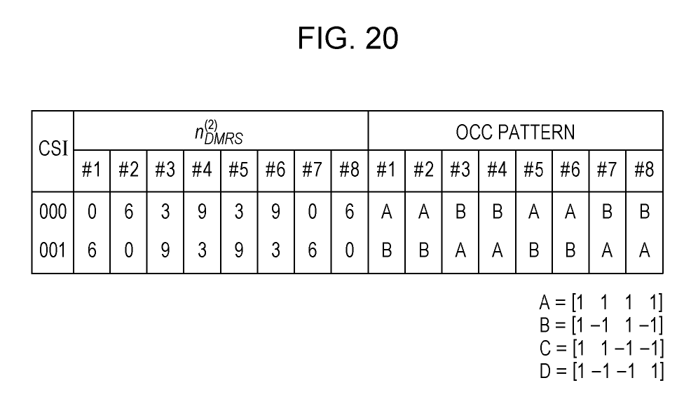

As in the second embodiment, in order to support MU-MIMO utilizing the same bandwidth, the table generator assigns the OCC pattern of the layer 5 of CSI=‘000’ to that of the layer 3 of CSI=‘001’, and also assigns the OCC pattern of the layer 6 of CSI=‘000’ to that of the layer 2 of CSI=‘001’. The table generator assigns OCC patterns in a similar manner. As a result, the table shown in FIG. 20 is obtained. A table in which individual spread codes (A through D) are appropriately assigned according to the above-described technique is the table shown in FIG. 17.

Concerning the spread codes A and B, +1 is multiplied in the SC-FDMA symbol #4 of each even-numbered subframe as the OCC pattern. As a result, when performing transmission using four or less layers by the use of CSI=‘000’, ‘001’, ‘011’, or ‘101’ using only A and B as the OCC patterns, the OCC patterns coincide with those of the table of Rel-10. Accordingly, by supplying information concerning the above-described CSI to Rel-10, it is possible to perform MU-MIMO while maintaining the compatibility with Rel-10. Additionally, in particular, concerning CSI=‘011’, the OCC patterns are all +1. Thus, by assigning CSI=‘011’ to a Rel-8 terminal device, it is also possible to perform MU-MIMO with Rel-8 while maintaining the backward compatibility.

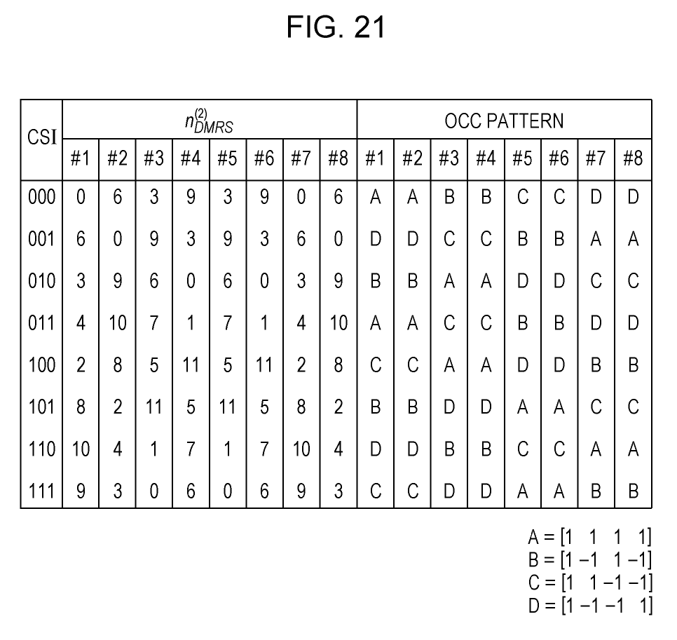

When MU-MIMO is performed by a terminal device to which CSI using only spread codes A and B (that is, CSI=‘000’, ‘001’, ‘011’, or ‘101’) is applied and a terminal device to which CSI using only spread codes C and D (that is, CSI=‘010’, ‘101’, ‘110’, or ‘111’) is applied, it is possible to perform MU-MIMO using eight layers and eight layers. In this case, the terminal devices are separated from each other by OCC patterns, it is not necessary that the terminal devices utilize the same bandwidth. Thus, the flexibility to perform scheduling by a base station can be enhanced. Additionally, since there are four OCC patterns, it is possible to perform MU-MIMO by four terminal devices using different bandwidths. For example, it is possible to perform MU-MIMO by four terminals, such as a terminal device which performs transmission using two layers by utilizing CSI=‘000’, a terminal device which performs transmission using two layers by utilizing CSI=‘001’, a terminal device which performs transmission using two layers by utilizing CSI=‘100’, and a terminal device which performs transmission using two layers by utilizing CSI=‘110’. In FIG. 17, only two OCC patterns are assigned to each CSI. Alternatively, four OCC patterns may be assigned to each CSI, as shown in FIG. 21. By assigning four OCC patterns to each CSI, the orthogonality of SU-MIMO performed by using five or more layers can be improved in a case in which frequency selective fading is strong and time selective fading is weak. In the tables shown in FIGS. 17 and 21, the same OCC pattern is used for the layer (2i+1) and the layer (2i+2) (i=1, 2). However, different OCC patterns may be used.

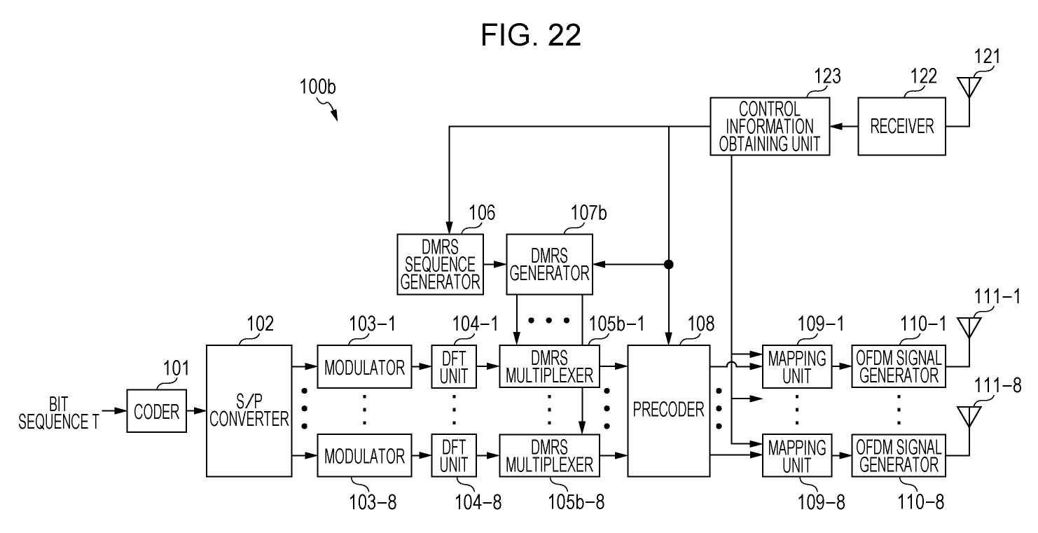

FIG. 22 is a schematic block diagram illustrating the configuration of a terminal device 100b according to this embodiment. The terminal device 100b is different from the terminal device 100 (FIG. 2) in that a DMRS generator 107b is provided. Functions of elements designated by the same reference numerals as those of the terminal device 100 are similar to the functions of the elements of the terminal device 100, and an explanation thereof will thus be omitted.

The DMRS generator 107b has functions similar to those of the DMRS generator 107 (see FIGS. 2 and 3) of the first embodiment. However, the DMRS generator 107b multiplexes four DMRSs in two subframes, as shown in FIG. 16.

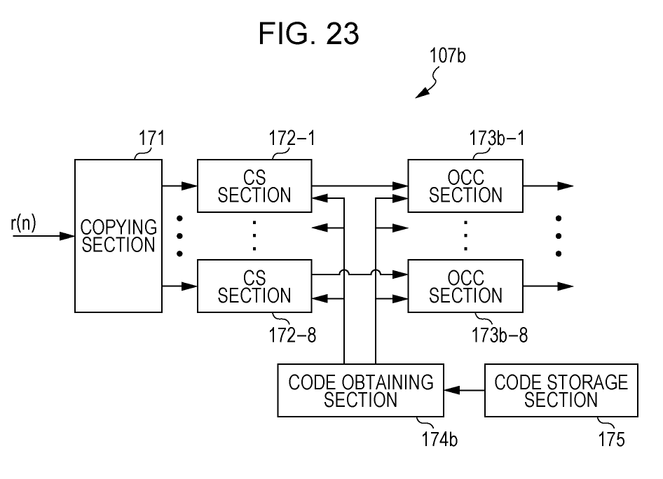

FIG. 23 is a schematic block diagram illustrating the configuration of the DMRS generator 107b according to this embodiment. The DMRS generator 107b is different from the DMRS generator 107 (see FIG. 3) in that a code obtaining section 174b and OCC sections 173b-1 through 173b-8 are provided. Functions of elements designated by the same reference numerals as those of the DMRS generator 107 are similar to the functions of the elements of the DMRS generator 107, and an explanation thereof will thus be omitted. The code storage section 175 stores therein the table shown in FIG. 17.

The code obtaining section 174b reads n_{DMRS}⁽²⁾ values corresponding to CSI information obtained by the control information obtaining unit 123 from the code storage section 175, and specifies cyclic shift amounts in the CS sections 172-1 through 172-8 on the basis of the read n_{DMRS}⁽²⁾ values. The code obtaining section 174b also reads OCC patterns corresponding to CSI information from the code storage section 175, and specifies the OCC patterns in the OCC sections 173b-1 through 173b-8. The OCC sections 173b-1 through 173b-L each apply the orthogonal cover codes (OCCs) of the OCC pattern specified by the code obtaining section 174b to an input sequence r^{(α)}(n). That is, the OCC sections 173b-1 through 173b-L each generate four DMRSs for #4 and #11 SC-FDMA symbols within the two subframes shown in FIG. 16.

For example, if the OCC pattern specified by the code obtaining section 174b is [+1, −1, −1, +1], the OCC section 173b-1 of the DMRS generator 107b sets the input sequence r^{(α)}(n) to be [r^{(α)}(n), −r^{(α)}(n)] in the (2I+1)-th subframe, and outputs [r^{(α)}(n), −r^{(α)}(n)] to the DMRS multiplexer 105b-1. In [r^{(α)}(n), −r^{(α)}(n)], the first element r^{(α)}(n) is DMRS for the #4 SC-FDMA symbol in the (2I+1)-th subframe and the second element −r^{(α)}(n) is DMRS for the #11 SC-FDMA symbol in the (2I+1)-th subframe.

In this case, the OCC section 173b-1 also sets the input sequence r^{(α)}(n) to be [−r^{(α)}(n), r^{(α)}(n)] in the (2I+2)-th subframe, and outputs [−r^{(α)}(n), r^{(α)}(n)] to the DMRS multiplexer 105b-1. In [−r^{(α)}(n), r^{(α)}(n)], the first element −r^{(α)}(n) is DMRS for the #4 SC-FDMA symbol in the (2I+2)-th subframe and the second element r^{(α)}(n) is DMRS for the #11 SC-FDMA symbol in the (2I+2)-th subframe.

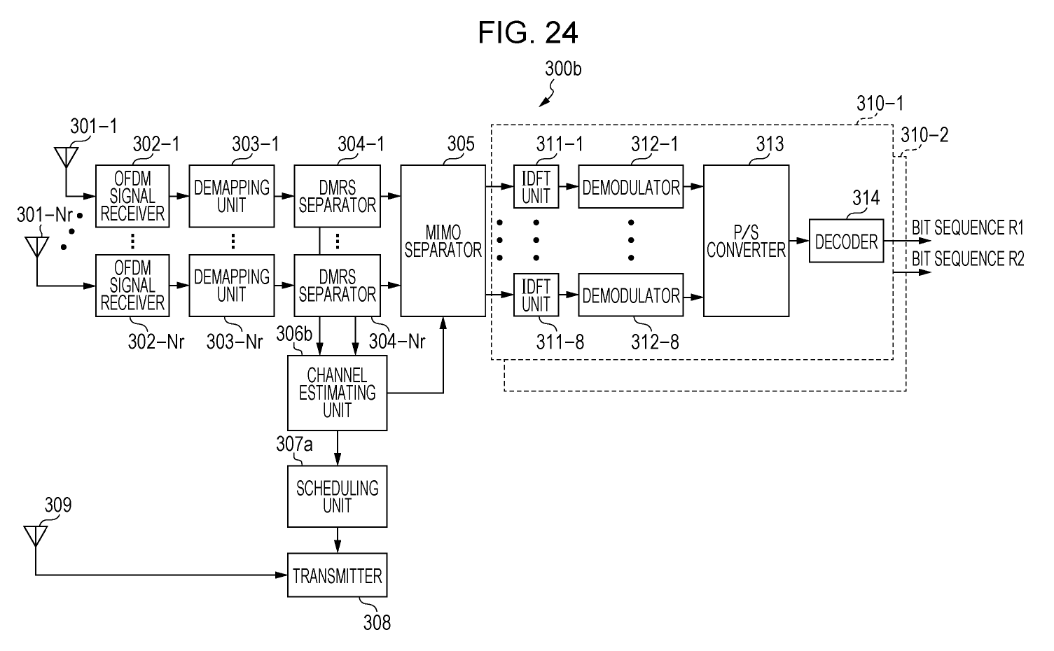

FIG. 24 is a schematic block diagram illustrating the configuration of a base station device 300b according to this embodiment.

The base station device 300b is different from the base station device 300a (FIG. 14) in that a channel estimating unit 306b is provided. Functions of elements designated by the same reference numerals as those of the base station device 300a are similar to the functions of the elements of the base station device 300a, and an explanation thereof will thus be omitted.

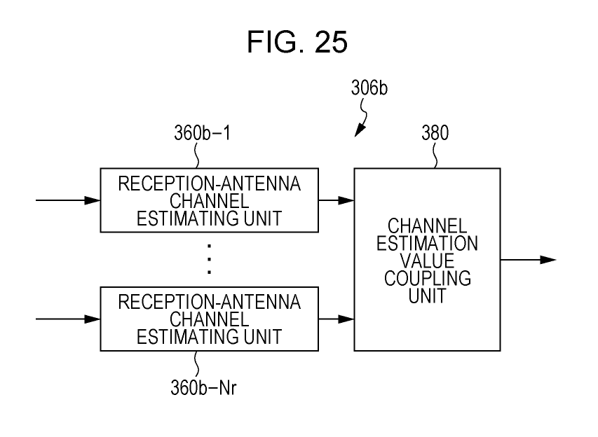

FIG. 25 is a schematic block diagram illustrating the configuration of the channel estimating unit 306b according to this embodiment. The channel estimating unit 306b is different from the channel estimating unit 306 (FIG. 6) in that reception-antenna channel estimating units 360b-1 through 360b-8 are provided. Functions of a channel estimation value coupling unit 380 are similar to those of the counterpart of the channel estimating unit 306, and an explanation thereof will thus be omitted.

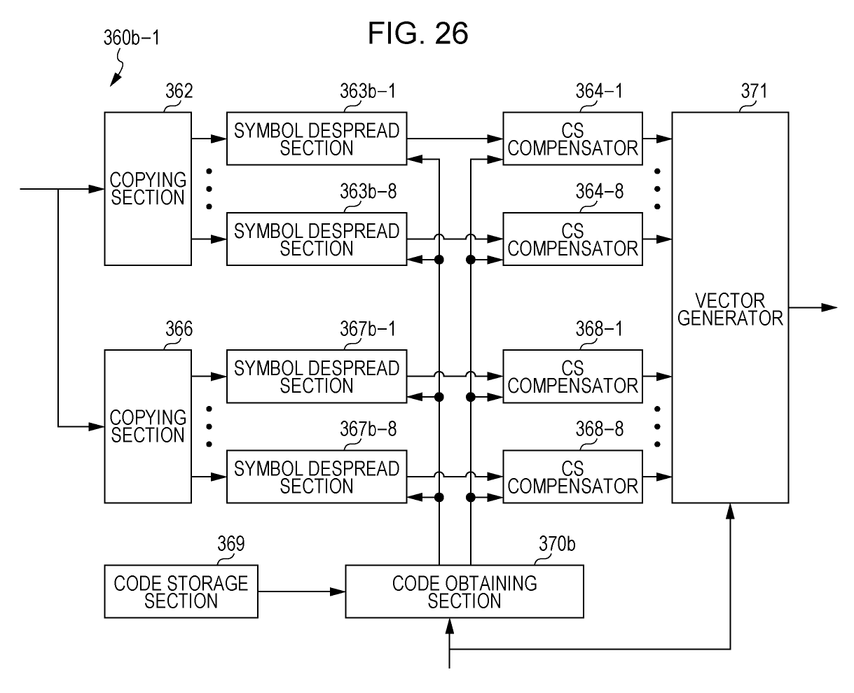

FIG. 26 is a schematic block diagram illustrating the configuration of the reception-antenna channel estimating unit 360b-1 according to this embodiment. The configurations of the other reception-antenna channel estimating units 360b-2 through 360b-Nr are similar to the configuration of the reception-antenna channel estimating unit 360b-1, and an explanation thereof will thus be omitted. The channel estimating unit 306b-1 is different from the channel estimating unit 306-1 (FIG. 7) in that a code obtaining section 370b and eight symbol despread sections 363b-1 through 363b-8 and 367b-1 through 367b-8 are provided. Functions of elements designated by the same reference numerals as those of the channel estimating unit 306-1 are similar to the functions of the elements of the channel estimating unit 306-1, and an explanation thereof will thus be omitted.

Vectors Rₘ(1×4) of received DMRS symbols constituted by SC-FDMA symbols #4 and #11 of two ((2I+1)-th and (2I+2)-th)) subframes included in a signal received by the reception antenna 301-1 are input into the reception-antenna channel estimating unit 360b-1. The extracted vectors are input into the copying section 362. The copying section 362 generates eight copies of the input vectors, and outputs the copied vectors to the symbol despread sections 363b-1 through 363-8b.

The symbol despread sections 363b-1 through 363b-8 each perform despread processing on OCCs applied in the terminal device 100b in accordance with instructions from the code obtaining section 370b. For example, the symbol despread sections 363b-1 through 363b-8 each perform despread processing on a layer having the same layer number as the branch number of the symbol despread section 363b, such as the symbol despread section 363b-1 performs despread processing on the layer #1, the symbol despread section 363b-2 performs despread processing on the layer #2, and so on. For example, a case in which the scheduling section 307b has assigned CSI=‘111’ and seven layers to the terminal device 100b will be considered. In this case, the code obtaining section 370b supplies information concerning CSI=‘111’ and [1, −1, −1, 1], which is the OCC pattern of the layer #5, to the symbol despread section 363b-5 (see FIG. 17). The symbol despread section 363b-5 multiplies the input vectors Rₘ by [1, −1, −1, 1] according to equation (6) on the basis of the received information.

[Math. 8]

Rₘ^{OCC}(n)=[1 −1 −1 1]Rₘ^{T} (8)

The symbol despread sections 367b-1 through 367b-8 are similar to the symbol despread sections 363b-1 through 363b-8, respectively, but the symbol despread sections 367b-1 through 367b-8 are different from the symbol despread sections 363b-1 through 363b-8 in that they process a signal transmitted from the terminal device 200.

In a wireless communication system in which reference signals are generated by using the table shown in FIG. 17, terminals which perform SU-MIMO using five or more layers can perform MU-MIMO by utilizing only partially overlapping bandwidths. If it is desired that the orthogonality of SU-MIMO be increased, the table shown in FIG. 21 may be employed as a system. If the table shown in FIG. 21 is employed, terminals which perform SU-MIMO using five or more layers are unable to perform MU-MIMO by utilizing only partially overlapping bandwidths. However, if time selective fading is weak, SU-MIMO transmission characteristics can be improved to a higher level than the use of the table shown in FIG. 17. In this embodiment, by the use of the table shown in FIG. 17 or 21, it is possible to perform MU-MIMO with a terminal which performs SU-MIMO using five or more layers.

As described above, in this embodiment, by the application of OCC patterns by using four DMRSs within two subframes, MU-MIMO performed by a terminal which performs transmission using eight layers and a terminal which performs transmission using eight layers and MU-MIMO performed by four terminals which each perform transmission using two layers can be implemented even if bandwidth used in the individual terminals are different. Additionally, the table discussed in this embodiment has tolerance to the frequency selectivity, as in the Rel-10 table. From these advantages, the throughput in a wireless communication system and the cell throughput can be significantly improved.

The functions of the individual elements shown in FIGS. 1, 2, 3, 5, 6, 7, 14, 22, 23, 24, 25, and 26 may be implemented in the following manner. A program for implementing these functions may be recorded on a computer-readable recording medium, and a computer system may be caused to read and execute the program recorded on this recording medium. In this case, the “computer system” includes an OS and hardware, such as peripheral devices.

A program operated in a terminal device and a base station device according to the present invention is a program which controls a CPU, etc. so that the functions of the above-described embodiments of the present invention can be implemented (a program which causes a computer to function). Then, information handled in these devices is temporarily stored in a RAM when being processed, and is then stored in various ROMs or an HDD. The information is read by the CPU when necessary and is updated or overwritten. As a recording medium which records the program, any type of recording medium, such as a semiconductor medium (for example, a ROM or a non-volatile memory card), an optical recording medium (for example, a DVD, an MO, an MD, a CD, or a BD), or a magnetic recording medium (for example, magnetic tape or a flexible disk) may be used. The functions of the above-described embodiments are implemented by operating a loaded program. Alternatively, the functions of the present invention may also be implemented by executing processing together with an operating system or another application program on the basis of instructions of the loaded program.

If the above-described program is put onto the market, it may be recorded on a portable recording medium and be distributed, or may be transferred to a server computer connected to the above-described devices via a network, such as the Internet. In this case, a storage device of a server computer is included in the present invention. Moreover, the entirety or part of the terminal device and the base station device of the above-described embodiments may be typically implemented by an LSI, which is an integrated circuit. The functional blocks of the terminal device and the base station device may be individually formed into chips or all or some of the functional blocks may be integrated into a chip. In this case, the terminal device, the base station device, or the functions thereof do not have to be integrated into an LSI, but they may be implemented by a dedicated circuit or a general-purpose processor. The circuit may be a hybrid circuit or a monolithic circuit. Some of the functions may be implemented by hardware and some of the functions may be implemented by software.

Moreover, due to the progress of semiconductor technologies, if a circuit integration technology which replaces an LSI technology is developed, an integrated circuit formed by such a technology may be used.

While the embodiments of the present invention have been described in detail with reference to the drawings, it is to be understood that specific configurations are not limited to the disclosed embodiments, and designs, for example, within the spirit of this invention are included in the scope of the claims.

### INDUSTRIAL APPLICABILITY

The present invention can find applications in a mobile communication system in which cellular phones are used as terminal devices.

### REFERENCE SIGNS LIST

100, 200, 100b terminal device, 300, 300a, 300b base station device, 101 coder, 102 S/P converter, 103-1 to 103-8 modulator, 104-1 to 104-8 DFT unit, 105-1 to 105-8 and 105b-1 to 105b-8 DMRS multiplexer, 106 DMRS sequence generator, 107, 107b DMRS generator, 108 precoder, 109-1 to 109-8 mapping unit, 110-1 to 110-8 OFDM signal generator, 111-1 to 111-8 transmission antenna, 121 reception antenna, 122 receiver, 123 control information obtaining unit, 172-1 to 172-8 CS section, 173-1 to 173-8 OCC section, 174 code obtaining section, 175 code storage section, 301-1 to 301-Nr reception antenna, 302-1 to 302-Nr OFDM signal receiver, 303-1 to 303-Nr demapping unit, 304-1 to 304-Nr DMRS separator, 305 MIMO separator, 306, 306b channel estimating unit, 307, 307a scheduling unit, 308 transmitter, 309 transmission antenna, 310-1 to 310-2 terminal signal processor, 311-1 to 311-8 IDFT unit, 312-1 to 312-8 demodulator, 313 P/S converter, 314 decoder, 360-1 to 360-Nr reception-antenna channel estimating unit, 380 channel estimation value coupling unit, 362 copying section, 363-1 to 363-8 symbol despread section, 364-1 to 364-8 CS compensator, 366 copying section, 367-1 to 367-8 symbol despread section, 368-1 to 368-8 CS compensator, 369 code storage section, 370 code obtaining section, 371 vector generator

1. A terminal device in a wireless communication system which includes a different terminal device that transmits a predetermined number of layers as a maximum number of layers to a base station device, the terminal device having a maximum number of layers which is greater than the predetermined number of layers, the terminal device comprising:
a reference signal generator that generates reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the different terminal device.

2. The terminal device according to claim 1, wherein the orthogonal codes are codes constituted by cyclic shifts and orthogonal cover codes.

3. The terminal device according to claim 1, wherein the reference signals generated by the reference signal generator are codes which increase, in a case in which the terminal device performs MU-MIMO with the different terminal device, a maximum total number of transmission layers of the terminal device and the number of transmission layers of the different terminal device to at least twice as many as the predetermined number of layers.

4. The terminal device according to claim 3, wherein the reference signals generated by the reference signal generator are codes to which, concerning each of layers exceeding the predetermined number of layers, one of combinations of the codes assigned up to the predetermined number of layers according to the assignment rules is assigned in an order opposite to an order of the assignment rules.

5. The terminal device according to claim 2, wherein:
the orthogonal cover codes are arranged after being spread in a time domain; and
the reference signals are codes in which the orthogonal cover codes assigned to the different terminal device are orthogonal to the orthogonal cover codes assigned to the terminal device.

6. The terminal device according to claim 5, wherein a spreading factor of the orthogonal cover codes is four.

7. A base station device which receives a predetermined number of layers as a maximum number of layers from a first terminal device, comprising:
a scheduling unit that generates control information for causing the second terminal device to generate reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device; and
a transmitter that transmits the control information to the second terminal device.

8. A wireless communication system comprising:
a base station device;
a first terminal device which transmits a predetermined number of layers as a maximum number of layers to the base station device; and
a second terminal device,
the base station device including
a scheduling unit that generates control information for causing the second terminal device to generate reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device, and
a transmitter that transmits the control information to the second terminal device,
the second terminal device including
a reference signal generator that generates, on the basis of the control information, reference signals used for demodulation to which orthogonal codes, which are a code for one layer and a code for another layer being orthogonal to each other, are assigned, concerning each of layers up to the predetermined number of layers, codes being assigned to the reference signals according to the same rules as assignment rules employed in the first terminal device.
